(19) United States
(12) Patent Application Publication
(10) Pub. No.: US 2007/0198633 A1
(43) Pub. Date: Aug. 23, 2007

(54) System and method for delivery of PC content through a server based relay system using really simple syndication

(75) Inventor: Jason Thibeault, Chandler, AZ (US)

Correspondence Address: ZARETSKY & ASSOCIATES PC, 8753 W. RUNION DR., PEORIA, AZ, 85382-6412, US

(73) Assignee: Q2 Labs, LLC

(21) Appl. No.: 11/458,955

(22) Filed: Jul. 20, 2006

Related U.S. Application Data
(60) Provisional application No. 60/701,663, filed on Jul. 20, 2005.

(51) Int. Cl. G06F 15/16; G06F 17/30; G06F 7/00

(52) U.S. Cl. 709/203; 707/1; 709/230

(57) ABSTRACT

A novel system and method for delivering personal computer (PC) based content through a server based relay system using really simple syndication (RSS). The mechanism of the present invention is operative to stream any type of PC content such as directories, files, video, audio, etc. A multimedia server (MMS) resides on the user's source computer (the “server”) and a multimedia client (MMC) resides on the destination or target computing device (the “client”). The MMS converts (i.e. translates or renders) files and resources to be delivered as an RSS document which can be further “stylized” through HTML style sheets (like XSTL) and delivered to anything capable of consuming web pages, such as an ordinary Internet browser like Microsoft Internet Explorer or a specialized reader (i.e. the MMC). The invention provides a user with complete access to the content on their PC through the MMS content server that resides on their source PC. The multimedia server translates or renders files to be delivered as an RSS document, while a reader (i.e. MMC) on the mobile device retrieves the content through HTTP requests to the URI of the file in the RSS document.

### REFERENCE TO PRIORITY APPLICATION

This application claims priority under 35 U.S.C. § 119(e) to U.S. Provisional Application Ser. No. 60/701,663, filed Jul. 20, 2005, entitled “System And Method For Delivery of PC Content To Mobile Devices Through A Server Based Relay System,” incorporated herein by reference in its entirety.

### FIELD OF THE INVENTION

The present invention relates to the field of data communications and more particularly relates to a system and method for delivering PC based content through a relay system using Really Simple Syndication (RSS) protocol.

### BACKGROUND OF THE INVENTION

In recent years the number of computers in use is increasing at an ever quickening pace. Along with the huge increase in the number of computers in use around the world, is a parallel increase in the number of computers connected to the Internet. Further, the world is witnessing an explosion of wireless devices that have the capability of connecting to the Internet as well. Such wireless devices include, for example, laptop computers, notebooks, palmtops, PDAs, cellular telephones with email and web browsing capabilities and other mobile wireless devices.

Often times, a user would need to transfer content between a personal computer (PC) (e.g., desktop or laptop) and a mobile device or other computer. Traditionally, the transfer of content between personal computers and mobile devices is typically carried out using (1) direct cables that physically connect both devices, (2) Bluetooth, WiMedia, UWB or some other short distance wireless access method or (3) removable media (e.g., digital flash memory based media cards, etc.).

In the case of direct cable and Bluetooth connections, the storage capacity on the receiving device (i.e. cellular phone, mobile device, laptop, desktop, etc.) must be sufficiently large enough to hold the PC content being transferred (e.g., video files, audio files, etc.). The problem is that the majority of the cellular phones and other mobile devices available today do not contain sufficient storage to hold the large sized files video, picture or audio files typically transferred. Further most cellular telephones and other types of mobile device do not have slots for flash memory media storage cards.

Moreover, very few services existing today provide a user the ability to stream media from their own personal computers. Rather, the majority of currently existing services supply the content that the end-user views on their device but they do not provide a delivery mechanism for this content.

There is thus a need for a mechanism that overcomes the disadvantages of the prior art. In particular, there is a need for a mechanism that is able to deliver PC content from one computing device to another without the need for direct physical connections between the two computing devices. Further, the mechanism should be able to stream contents from a user's PC without requiring the availability of large flash media cards on the receiving computing device.

### SUMMARY OF THE INVENTION

The present invention is a system and method for delivering personal computer (PC) based content through a server based relay system using really simple syndication (RSS). The mechanism of the present invention is operative to stream any type of PC content such as directories, files such as pictures (JPG, BMP, etc.), video (MPG, AVI, etc.) and audio (MP3, MPC, WMA, etc.) and application data (email from Microsoft Outlook, etc.).

The mechanism comprises a multimedia server (MMS) that resides on the user's source computer (i.e. the computer with the content to be accessed; the “server”) and a multimedia client (MMC) that resides on the destination or target computing device (the “client”). It is important to note that it is not required that the MMC be implemented as a separate application. This is because the MMS is operative to generate RSS content that can be formatted into HTML. Thus, the “client” can simply be an ordinary web browser. The destination or target computing device can comprise any type of processing device such as a desktop PC, laptop PC, notebook, palmtop, PDA, cellular telephone with web access, etc., and is not critical to the invention.

The mechanism of the present invention provides a user with complete access to the content on their PC (e.g., audio, video, files, application data, etc.) through the MMS content server that resides on their source PC. The multimedia server converts (i.e. translates or renders) files and resources to be delivered as an RSS document which can be further “stylized” through HTML style sheets (like XSTL) and delivered to anything capable of consuming web pages, such as for example, an ordinary Internet browser like Microsoft Internet Explorer or a specialized reader. An illustrative example of the application of the mechanism of the invention to a music player is provided infra.

The mechanism of the invention is also operative to render (i.e. generate) the RSS documents from the various PC items selected by a user to be made available to the MMC device. In the event the desired PC items include application data (e.g., emails within an email application, or other application specific items), the invention provides a mechanism for representing application data as RSS documents. Further, the invention provides a mechanism for the delivery of RSS documents to the multimedia client and for permitting the user at the client device to interact with the RSS document displayed as a web page through clicking on “elements” of the RSS document that are represented on the web page as links and operate as ordinary HTML. Clicking on a link is processed by the MMS (which includes an integrated web server capable of processing such requests) and may point to a local file (in which case the link is a Universal Resource Indicator (URI) to the file on the local hard drive where the MMS is located) or an external resource (i.e. a file on a network drive or located elsewhere on the Internet).

The invention also comprises a relay mechanism whereby the location of the MMS on the Internet does not need to be known by the MMC. MMSs register their locations with a third party authentication server located anywhere on the Internet. The MMC requests from the authentication server the location of an MMS using a unique serial number assigned to and used to uniquely identify each MMS. In this architecture, the relationship between the MMS and the MMC is a “peer-to-peer” relationship wherein the MMC makes direct requests to the MMS and such requests are not processed by a third-party computing agent and then delivered to the MMS.

Note that some aspects of the invention described herein may be constructed as software objects that are executed in embedded devices as firmware, software objects that are executed as part of a software application on either an embedded or non-embedded computer system such as a central processing unit (CPU), digital signal processor (DSP), microcomputer, minicomputer, microprocessor, etc. running a real-time operating system such as WinCE, Symbian, OSE, Embedded LINUX, etc. or non-real time operating system such as Windows, UNIX, LINUX, etc., or as soft core realized HDL circuits embodied in an Application Specific Integrated Circuit (ASIC) or Field Programmable Gate Array (FPGA), or as functionally equivalent discrete hardware components.

There is therefore provided in accordance with the invention, a method of delivering personal computer (PC) content over a network, the method comprising the steps of rendering, on a multimedia server (MMS), a plurality of PC based items as really simple syndication (RSS) documents and storing the RSS documents in memory, generating, on a multimedia client (MMC), a request for one or more RSS documents, in response to the request, retrieving one or more RSS documents on the server from the memory and sending the one or more RSS documents retrieved to the multimedia client.

There is also provided in accordance with the invention, a method of delivering personal computer (PC) content over a network, the method comprising the steps of requesting from an authentication service a location of a multimedia server (MMS) running on a user's PC, establishing a peer-to-peer connection between a multimedia client (MMC) and the MMS, rendering, on the MMS, a plurality of PC based items as really simple syndication (RSS) documents and storing the RSS documents in memory, generating on the MMC a request for one or more RSS documents and forwarding the request to the MMS, in response to the request, retrieving one or more RSS documents on the MMS from the memory and sending the one or more RSS documents retrieved to the MMC.

There is further provided in accordance with the invention, a system for delivering personal computer (PC) content over a network comprising a really simple syndication (RSS) document database located on one or more servers, the RSS document database for storing one or more RSS documents, each RSS document associated with a particular PC based item, one or more multimedia clients (MMCs) coupled to the network, each MMC operative to generate a request message for an RSS document in response to a user input command, each MMC operative to send the request message to a multimedia server (MMS) coupled to the network, and to process and display the requested RSS document received from the MMS and the MMS operative to render a plurality of PC items, each PC item rendered as an RSS document stored in the RSS document database, the MMS operative to receive the request message from the MMC and, in response thereto, to retrieve the requested RSS document from the RSS database and forward the requested RSS document to the MMC.

There is also provided in accordance with the invention, a method of delivering personal computer (PC) content over a network for use on a multimedia server (MMS) computer coupled to the network, the method comprising the steps of rendering a plurality of PC based items as really simple syndication (RSS) documents and storing the RSS documents in an RSS document database, receiving a request for one or more RSS documents from a multimedia client (MMC) coupled to the network, in response to the request, retrieving one or more RSS documents from the RSS document database and sending the one or more requested RSS documents to the multimedia client.

There is further provided in accordance with the invention, a multimedia server (MMS) coupled to a network for delivering personal computer (PC) content over the network comprising a really simple syndication (RSS) document database for storing one or more RSS documents, each RSS document associated with a particular PC based item, a user configuration database for storing an index of application related data selected to be viewed by a user, a web server operative to receiving requests for RSS documents from one or more multimedia clients (MMCs) coupled to the network and to display a web page containing the requested RSS document to the MMC and an RSS agent coupled to the RSS document database, the user configuration database and the web server, the RSS agent operative to render user selected PC based items as RSS documents utilizing the user configuration database and to store the RSS documents in the RSS document database, the RSS agent operative to retrieve an RSS document from the RSS document database in response to a request received from an MMC and to forward the requested RSS document to the requesting MMC, the RSS agent operative to retrieve application specific data utilizing the user configuration database in response to a corresponding request received from an MMC.

There is also provided in accordance with the invention, a computer program product comprising a computer usable medium having computer usable program code for delivering personal computer (PC) content over a network, the computer program product including, computer usable program code for rendering a plurality of PC based items as really simple syndication (RSS) documents and storing the RSS documents in an RSS document database, computer usable program code for receiving a request for one or more RSS documents from a multimedia client (MMC) coupled to the network, computer usable program code for in response to the request, retrieving one or more RSS documents from the RSS document database and computer usable program code for sending the one or more requested RSS documents to the multimedia client.

### BRIEF DESCRIPTION OF THE DRAWINGS

The invention is herein described, by way of example only, with reference to the accompanying drawings, wherein:

FIG. 1 is a block diagram illustrating an example network incorporating an authentication server, multimedia server (MMS) and multimedia client (MMC), all constructed in accordance with the present invention;

FIG. 2 is a block diagram illustrating an example computer processing system architecture suitable for use with the present invention.

FIG. 3 is a block diagram illustrating an example mobile device or PDA system architecture suitable for use with the present invention.

FIG. 4 is a block diagram illustrating the authentication server of the present invention in more detail;

FIG. 5 is a block diagram illustrating the multimedia client (MMC) of the present invention in more detail;

FIG. 6 is a block diagram illustrating the multimedia server (MMS) of the present invention in more detail;

FIG. 7 is a block diagram illustrating the processing sequence of the RSS based PC content delivery system of the present invention;

FIG. 8 is a flow diagram illustrating the method of representing application data in RSS format;

FIG. 9 is a flow diagram illustrating the request/response method of the multimedia client;

FIG. 10 is a diagram illustrating the logical architecture of the MMS application of an example application of the invention to a music retrieval system;

FIG. 11 is a diagram illustrating the logical architecture of the MMS server portion of the example music retrieval system;

FIG. 12 is a diagram illustrating the logical architecture of the IP authentication server of the example music retrieval system;

FIG. 13 is a diagram illustrating the logical architecture of the MMC of the example music retrieval system;

FIG. 14 is a diagram illustrating the sequencing for the Start Server task;

FIG. 15 is a diagram illustrating the sequencing for the Stop Server task;

FIG. 16 is a diagram illustrating the sequencing for Auto Start Server task;

FIG. 17 is a diagram illustrating the sequencing for the Search Files task;

FIG. 18 is a diagram illustrating the sequencing for the Share Music File task;

FIG. 19 is a diagram illustrating the sequencing for the Manage Files task;

FIG. 20 is a diagram illustrating the sequencing for the Manage Play List task;

FIG. 21 is a diagram illustrating the sequencing for the Create User task;

FIG. 22 is a diagram illustrating the sequencing for the Import Play List task;

FIG. 23 is a diagram illustrating the sequencing for the MMS Preferences task;

FIG. 24 is a diagram illustrating the sequencing for the Help task;

FIG. 25 is a diagram illustrating the sequencing for the About MMS task;

FIG. 26 is a diagram illustrating the sequencing for the Login task;

FIG. 27 is a diagram illustrating the sequencing for the Logout task;

FIG. 28 is a diagram illustrating the sequencing for the Search task;

FIG. 29 is a diagram illustrating the sequencing for the Preferences task;

FIG. 30 is a diagram illustrating the sequencing for the Play task;

FIG. 31 is a diagram illustrating the sequencing for the Change Password task;

FIG. 32 is a diagram illustrating the sequencing for the MMS Server task;

FIG. 33 is a diagram illustrating the sequencing for the IP Authentication Service task;

FIG. 34 is a diagram illustrating the overall sequencing for the MMC;

FIG. 35 is a screen shot of the Music Application main dialog box;

FIG. 36 is a screen shot of an example Show Music Files dialog box of the example music retrieval system;

FIG. 37 is a screen shot of an example Create User dialog box of the example music retrieval system;

FIG. 38 is a screen shot of an example Preferences dialog box of the example music retrieval system;

FIG. 39 is a screen shot of an example MMC Login dialog box of the example music retrieval system;

FIG. 40 is a screen shot of an example MMC Search dialog box of the example music retrieval system; and

FIG. 41 is a screen shot of an example MMC Preferences dialog box of the example music retrieval system.

### DETAILED DESCRIPTION OF THE INVENTION

### Notation Used Throughout

The following notation is used throughout this document.

Term Definition

API Application Programming Interface

ASIC Application Specific Integrated Circuit

AVI Audio Video Interleave

BMP Windows Bitmap

CD-ROM Compact Disc-Read Only Memory

CPU Central Processing Unit

DSP Digital Signal Processor

EEROM Electrically Erasable Read Only Memory

FM Frequency Modulation

FPGA Field Programmable Gate Array

FTP File Transfer Protocol

GUI Graphical User Interface

HTTP Hypertext Transfer Protocol

HTTPS SSL secured HTTP

IP Internet Protocol

JPG Joint Photographic Experts Group

LAN Local Area Network

MAC Media Access Control

MD5 Message-Digest algorithm 5

MMC Multimedia Client

MMS Multimedia Server

MPC Media Player Classic

MPG Motion Picture Group

NIC Network Interface Card

PC Personal Computer

PDA Personal Digital Assistant

RAM Random Access Memory

RF Radio Frequency

ROM Read Only Memory

RSA Rivest Shamir Adleman encryption algorithm,

RSS Really Simple Syndication

SIM Subscriber Identity Module

URI Uniform Resource Identifier

USB Universal Serial Bus

UWB Ultra Wideband

WAN Wide Area Network.

WMA Windows Media Audio

WWAN Wireless Wide Area Network

XHTML Extensible HyperText Markup Language

XML Extensible Markup Language

XSTL eXtensible Style Sheet Language Transformation

The present invention is a system and method for delivering personal computer (PC) based content through a server based relay system using really simple syndication (RSS). The mechanism of the present invention is operative to stream any type of PC content such as directories, files such as pictures (JPG, BMP, etc.), video (MPG, AVI, etc.) and audio (MP3, MPC, WMA, etc.).

Some portions of the detailed descriptions which follow are presented in terms of procedures, logic blocks, processing, steps, and other symbolic representations of operations on data bits within a computer memory. These descriptions and representations are the means used by those skilled in the data processing arts to most effectively convey the substance of their work to others skilled in the art. A procedure, logic block, process, etc., is generally conceived to be a self-consistent sequence of steps or instructions leading to a desired result. The steps require physical manipulations of physical quantities. Usually, though not necessarily, these quantities take the form of electrical or magnetic signals capable of being stored, transferred, combined, compared and otherwise manipulated in a computer system. It has proven convenient at times, principally for reasons of common usage, to refer to these signals as bits, bytes, words, values, elements, symbols, characters, terms, numbers, or the like.

It should be borne in mind that all of the above and similar terms are to be associated with the appropriate physical quantities they represent and are merely convenient labels applied to these quantities. Unless specifically stated otherwise as apparent from the following discussions, it is appreciated that throughout the present invention, discussions utilizing terms such as ‘processing,’ ‘computing,’ ‘calculating,’ ‘determining,’ ‘displaying’ or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

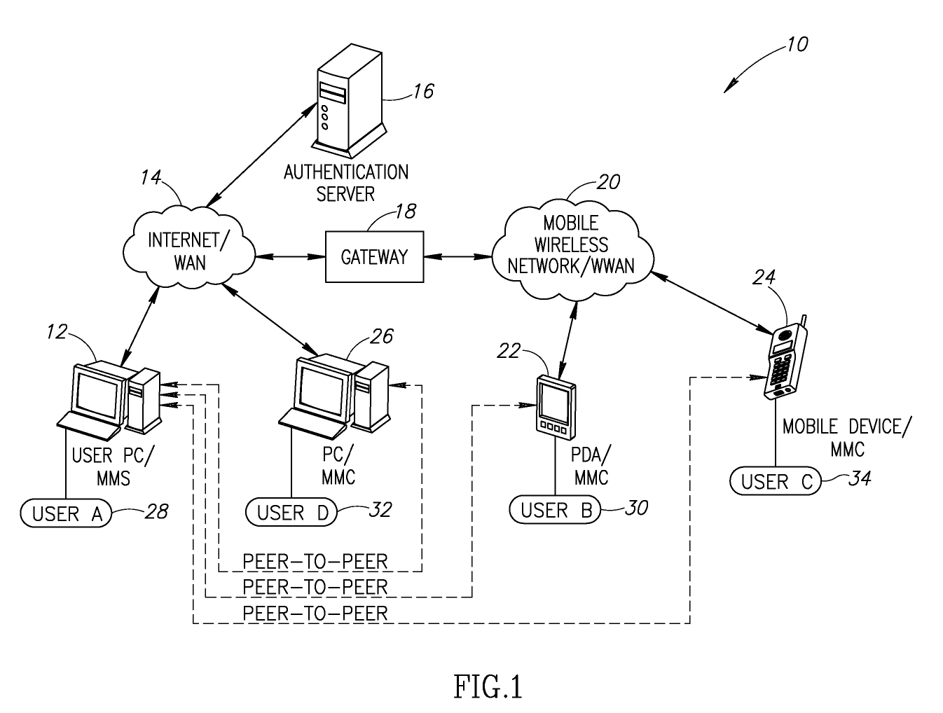

A block diagram illustrating an example network incorporating an authentication server, multimedia server (MMS) and multimedia client (MMC), all constructed in accordance with the present invention is shown in FIG. 1. The example network, generally referenced 10, comprises an Internet/WAN cloud 14, mobile wireless network (e.g., Wireless Wide Area Network (WWAN)) 20, gateway 18, authentication server 16, user PC/MMS 12, PDA based MMC 22, PC based MMC 26, mobile device based MMC 24 and users A 28, B 30, C 32 and D 34.

The multimedia server (MMS) 12 resides on the user's source computer (i.e. the computer with the content to be accessed; hereinafter referred to as the “server” or MMS). The multimedia client (MMC) resides on the destination or target computing device (hereinafter the “client” or MMC). The MMC may be construed as any software, hardware or combination of software and hardware, capable of communicating with the MMS which includes, but is not limited to, a conventional web browser, a custom application or any other software that can access HTML and render such to the end user. The destination or target computing device can comprise any type of processing device such as a desktop PC, laptop PC, notebook, palmtop, PDA, cellular telephone with web access, etc., and is not critical to the operation of the invention.

The mechanism of the present invention provides a user with complete access to the content on their PC (e.g., audio, video, files, application data, etc.) through the MMS content server that resides on their source PC. The multimedia server converts (i.e. translates or renders) files and resources to be delivered as an RSS document which can be further “stylized” through HTML style sheets (like XSTL) and delivered to anything capable of consuming web pages, such as for example, an ordinary Internet browser like Microsoft Internet Explorer or a specialized reader.

The invention also comprises a relay mechanism whereby the location of the MMS on the Internet does not need to be known by the MMC. MMSs register their locations with a third party authentication server located anywhere on the Internet. The MMC requests from the authentication server the location of an MMS using a unique serial number assigned to and used to uniquely identify each MMS.

Once the location of the MMS is known, a peer-to-peer connection with the MMS is created as indicated in FIG. 1. Via the peer-to-peer relationship the MMS and MMC communicate directly with each other rather than through a third party intermediary for translation or processing.

Note that in this example, the manner of how the MMC communicates with the MMS is not critical to the invention. For illustrative purposes only, user B uses a wireless PDA and user C uses a mobile device such as a cellular telephone wherein each connects to the Internet through the wireless network 20. The PC is shown connected directly to the Internet, however, it is appreciated that a laptop equipped with a wireless card can communicate over the wireless network 20 as well.

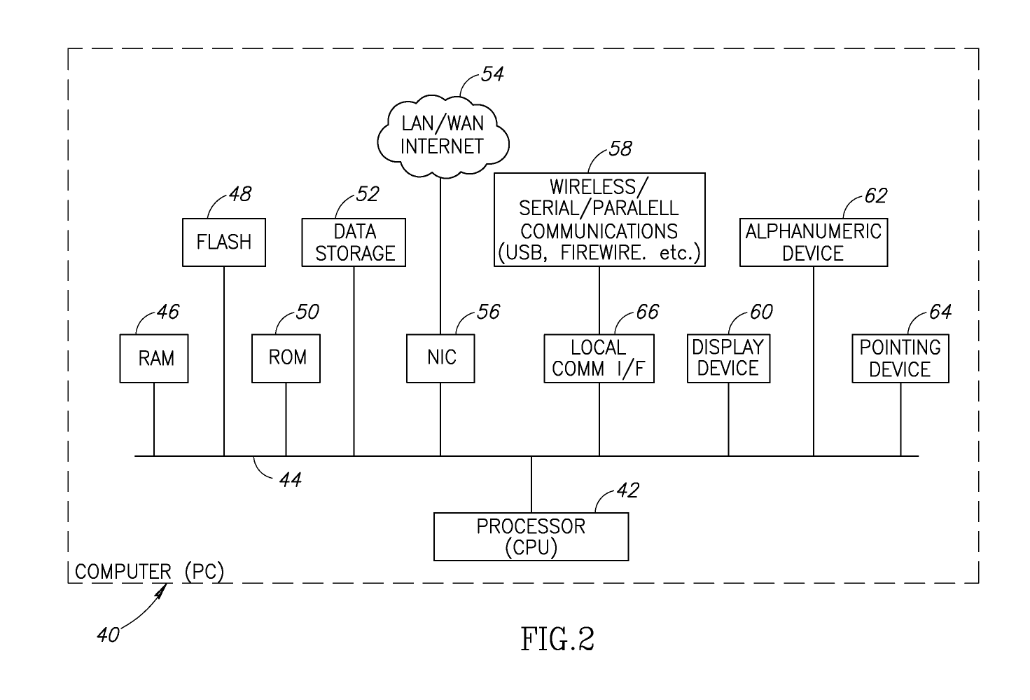

A block diagram illustrating an example computer processing system architecture suitable for use with the present invention is shown in FIG. 2. The computer system, generally referenced 40, comprises a processor 42 which may comprise a digital signal processor (DSP), central processing unit (CPU), microcontroller, microprocessor, microcomputer, ASIC or FPGA core. The system also comprises static read only memory 50 and dynamic main memory 46 all in communication with the processor. The processor is also in communication, via bus 44, with a number of peripheral devices that are also included in the computer system. Peripheral devices coupled to the bus include a display device 60 (e.g., monitor), alpha-numeric input device 62 (e.g., keyboard) and pointing device 64 (e.g., mouse, tablet, etc.)

The computer system is connected to one or more external networks such as a LAN or WAN 54 via communication lines connected to the system via a network interface card (NIC). A local communications I/F 66 provides connections to various wireless, serial and parallel devices. Examples include Bluetooth, UWB, USB, Firewire, etc. The network adapters 56 and local communications I/F 66 coupled to the system enable the data processing system to become coupled to other data processing systems or remote printers or storage devices through intervening private or public networks. Modems, cable modem and Ethernet cards are just a few of the currently available types of network adapters.

The system also comprises magnetic or semiconductor based storage device 52 for storing application programs and data. The system comprises computer readable storage medium that may include any suitable memory means, including but not limited to, magnetic storage, optical storage, semiconductor volatile or non-volatile memory, biological memory devices, or any other memory storage device.

Software adapted to implement the RSS based PC content delivery mechanism is adapted to reside on a computer readable medium, such as a magnetic disk within a disk drive unit. Alternatively, the computer readable medium may comprise a floppy disk, removable hard disk, Flash memory 46, EEROM based memory, bubble memory storage, ROM storage, distribution media, intermediate storage media, execution memory of a computer, and any other medium or device capable of storing for later reading by a computer a computer program implementing the method of this invention. The software adapted to implement the RSS based PC content delivery mechanism of the present invention may also reside, in whole or in part, in the static or dynamic main memories or in firmware within the processor of the computer system (i.e. within microcontroller, microprocessor or microcomputer internal memory).

Other digital computer system configurations can also be employed to implement the RSS based PC content delivery mechanism of the present invention, and to the extent that a particular system configuration is capable of implementing the system and methods of this invention, it is equivalent to the representative digital computer system of FIG. 2 and within the spirit and scope of this invention.

Once they are programmed to perform particular functions pursuant to instructions from program software that implements the system and methods of this invention, such digital computer systems in effect become special purpose computers particular to the method of this invention. The techniques necessary for this are well-known to those skilled in the art of computer systems.

It is noted that computer programs implementing the system and methods of this invention will commonly be distributed to users on a distribution medium such as floppy disk or CD-ROM or may be downloaded over a network such as the Internet using FTP, HTTP, or other suitable protocols. From there, they will often be copied to a hard disk or a similar intermediate storage medium. When the programs are to be run, they will be loaded either from their distribution medium or their intermediate storage medium into the execution memory of the computer, configuring the computer to act in accordance with the method of this invention. All these operations are well-known to those skilled in the art of computer systems.

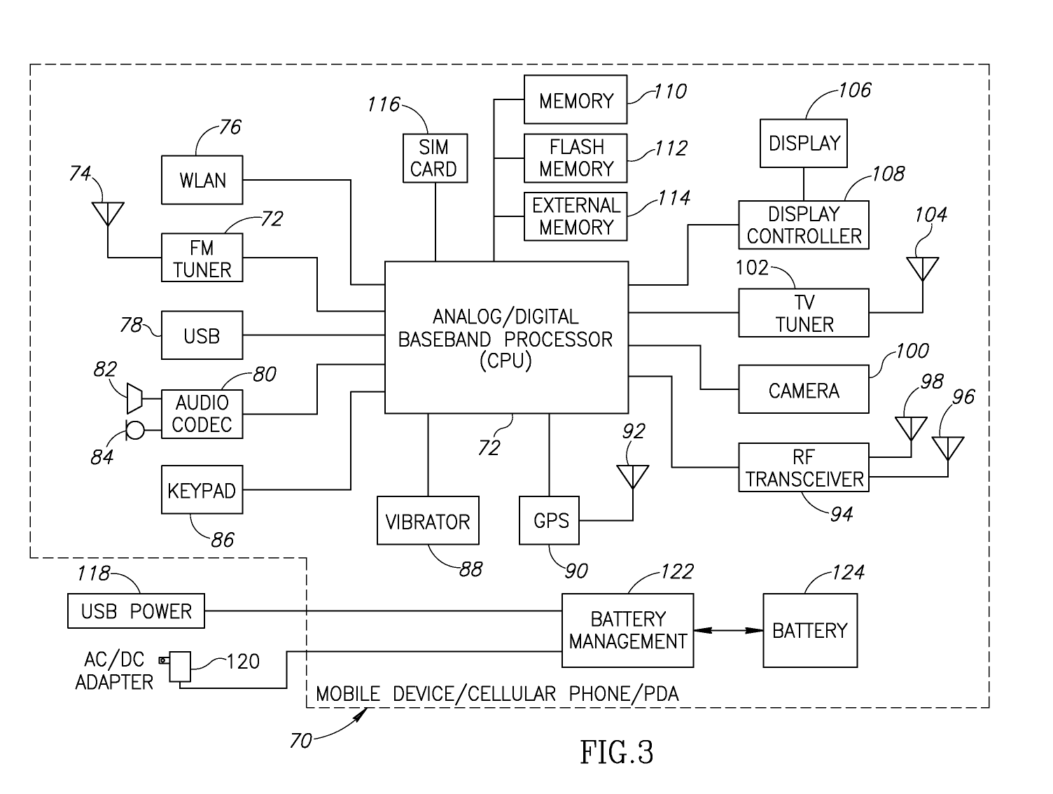

A block diagram illustrating an example mobile device/cellular phone/PDA system architecture suitable for use with the present invention is shown in FIG. 3. The mobile device/cellular phone/PDA (hereinafter the “cell phone”), generally referenced 70, comprises a baseband processor or CPU 72 having analog and digital portions. The basic cellular link is provided by the RF transceiver 94 and related one or more antennas 96, 98. A plurality of antennas are used to provide antenna diversity which yields improved radio performance. The cell phone also comprises internal RAM and ROM memory 110, Flash memory 112 and external memory 114.

Several user interface devices include microphone 84, speaker 82 and associated audio codec 80, a keypad for entering dialing digits 86, vibrator 88 for alerting a user, camera and related circuitry 100, a TV tuner 102 and associated antenna 104, display 106 and associated display controller 108 and GPS receiver and associated antenna 92.

A USB interface connection 78 provides a serial link to a user's PC or other device. An FM tuner 72 and antenna 74 provide the user the ability to listen to FM broadcasts. WLAN interface 76 provides wireless connectivity when in a hot spot or within the range of an ad hoc, infrastructure or mesh based wireless network. SIM card 116 provides the interface to a user's SIM card for storing user data such as address book entries, etc.

Portable power is provided by the battery 124 coupled to battery management circuitry 122. External power is provided via USB power 118 or an AC/DC adapter 120 connected to the battery management circuitry which is operative to manage the charging and discharging of the battery 124.

### Authentication Server

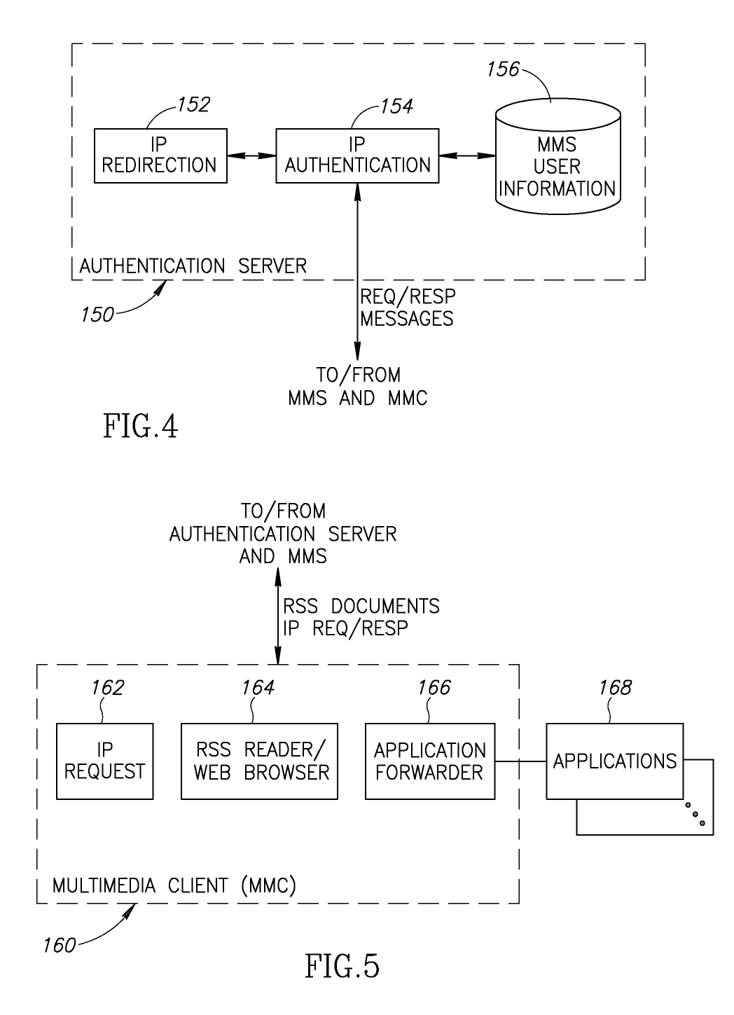

A block diagram illustrating the authentication server of the present invention in more detail is shown in FIG. 4. The authentication server, generally referenced 150, comprises an IP redirection module 152, IP authentication module 154 and an MMS user information database 156. The authentication service is a third party service provided by a remote server that can reside anywhere on the Internet. Its purpose is to relay the location of multimedia servers to requesting multimedia clients. The operation of the various components of the authentication server will now be described in more detail.

In operation, each MMS communicates (i.e. registers) its WAN IP address to the IP authentication server before any PC content can be delivered. The transfer of the IP address and related server information is encrypted at the MMS before transmission utilizing a standard encryption methodology (e.g., public/private key, RSA, Blowfish, etc.). The MMS transmits this message to the authentication server by way of HTTPS (SSL secured HTTP communication). The authentication server listens for transmission traffic on a specific IP address and port number. When an MMS attempts to deliver data to that IP address and/or port number, it first sends its serial number in a hash sequence to the authentication server which decrypts the information to reveal the serial number. Note that only an authentication server with the correct hash key can decrypt the unique serial number within the hash that was encrypted using the same key by the MMS. Note also that the serial number is generated through a random process by the company delivering the MMS to the end user and provided to the user once payment for the MMS has been processed.

Once the serial number has been verified after being decrypted, the authentication server creates a unique “connection key” that is transmitted to the MMS. This key is then appended to each and every transmission between the MMS and the authentication server during the transaction of sending data from the MMS to the authentication server. Any communication that does not have a key appended to it will not be recognized by the authentication server. The data from the MMS is then sent in encrypted text to the authentication server which decrypts the message from the MMS and verifies it against a record in the user information database using the MAC address as the primary key. If no record is found, a unique serial number is generated corresponding to the MMS. A new record is created in the user information database and the serial number along with the IP address, MAC address and port number of the MMS are stored therein. The record stored in the authentication server user information database comprises the IP address, MAC address and port number of the MMS on the user's PC.

If the MMS sending the message is already registered and the MMS is verified to be authentic, the IP authentication module updates the record in the user information database corresponding to the MAC address in the message with the current WAN IP address of the MMS. In this manner, the authentication server is kept up to date when the MMS changes location.

When a MMC requests the location of a MMS, it sends a request to the authentication server. The request includes the unique serial number previously assigned to the MMS. The user information database is searched for a matching MMS record using the serial number as the key. If a matching MMS record is found and if the received request is from a browser, the IP redirection module is operative to HTTP redirect the browser to the IP address on record for the MMS in the request. The redirection can be accomplished through a simple web based form into which the user enters the unique serial number corresponding to the MMS, a username, and one or more credentials. The IP redirection module retrieves the WAN IP address and port number from the user configuration database and passes the web browser request to the requesting user client which then redirects to that IP address, passing the encrypted username and password encrypted with the serial number of the MMS to the MMS where it is decrypted using the MMS serial number. Once decrypted, a unique session is created that is shared between the MMS and the MMC or conventional web browser for the transmission session.

### Multimedia Client (MMC)

A block diagram illustrating the multimedia client (MMC) of the present invention in more detail is shown in FIG. 5. The multimedia client (MMC), generally referenced 160, comprises an IP request module 162, RSS reader 164 and application forwarder 166. It is important to note that the MMC can reside on any suitable computing device and is not limited to mobile or cellular devices. For example, the MMC can reside on cellular phones, mobile devices, PDAs, desktop PCs, laptop PCs, palmtop devices, or any other wired or wireless computing device. In accordance with the invention, it is not critical that the MMC comprise a unique software application. Alternatively, the MMC may comprise a conventional web browser that is capable of transmitting, receiving and rendering HTML.

The RSS reader is a software application that runs on the client for processing and displaying (i.e. rendering) the RSS document stored on the user's computer which was generated by the MMS and delivered to the MMC via the network. The RSS reader also provides connectivity to the MMS and authentication server. The RSS reader application provides basic functionality, such as search, browse, select, etc., that allows the user to interact with the RSS document and retrieve elements from the user's PC via the MMS. This is accomplished when the user clicks on an item within the list displayed by the MMC on the client. The RSS reader requests the selected object from the MMS using the item's URI. The MMS, in response, sends (i.e. streams) the item to the MMC for processing and display by the RSS reader.

When the RSS reader first establishes a connection directly with the MMS, the reader sends credentials which are validated and authenticated by the RSS agent portion of the MMS on the user's computer. The credential comprise username, password and serial number of the MMS.

The IP request module is operative to initiate a connection to the authentication server by sending a request to the authentication server for the IP Address of the MMS it wants to connect to. The request comprises the unique serial number and/or MAC address associated with the MMS. The authentication server, via the IP authentication module, is operative to authenticate the message and retrieve the WAN IP address and port number of the MMS corresponding to the serial number included with the request. The IP address and port number are then sent to the MMC whereby the RSS reader configures and creates a direct connection with the desired MMS using the WAN IP address and port number.

The application forward module functions to forward the RSS document sent by the MMS to the particular application(s) 168 that is designated to handle that type of document on the client computing device. In the case a document type is received wherein the supporting application is not known, the user can be queried for the application to open the file with.

### Multimedia Server (MMS)

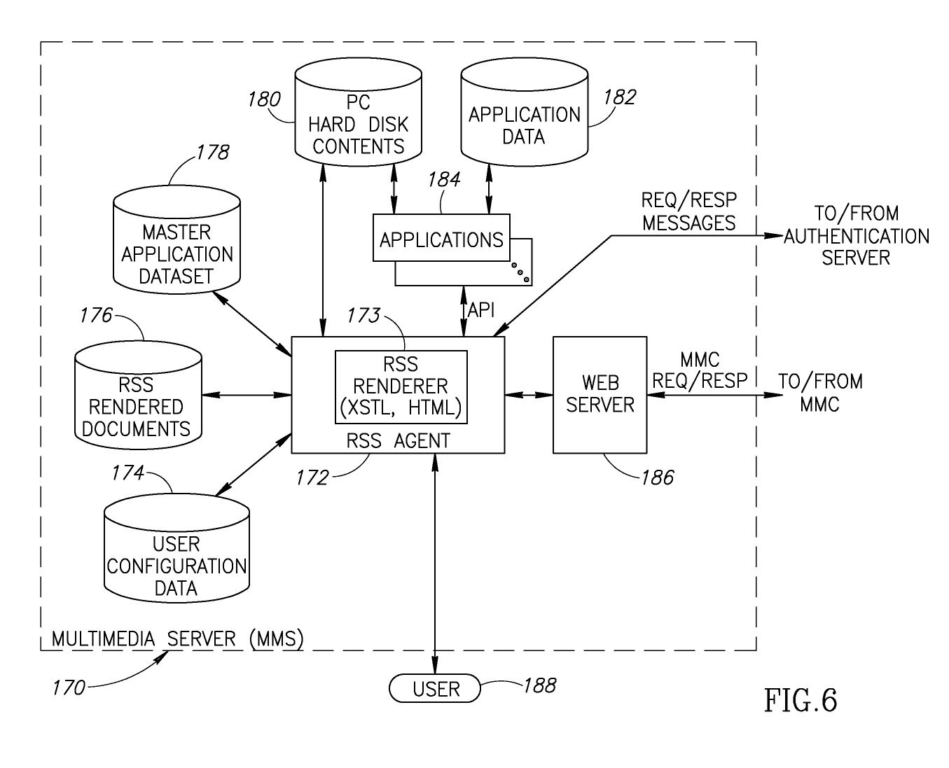

A block diagram illustrating the multimedia server (MMS) of the present invention in more detail is shown in FIG. 6. The multimedia server (MMS), generally referenced 170, comprises an RSS agent 172, user configuration database 174, RSS rendered documents database 176, master application dataset 178 and web server 186. The agent comprises an RSS renderer 173 adapted to render files and resources in RSS format. In addition the renderer is operative to “translate” or “style” the RSS, a subset of XML, through extensible Style Sheet (XSTL) into HTML. The HTML is then consumed by any application capable of rendering HTML content, such as a conventional web browser. This mechanism allows “serialized content” such as RSS to be embedded into an otherwise normal looking webpage and not a list of RSS data elements.

The primary function of the RSS agent is to take input (i.e. PC items such as files, etc.) from the user and convert the input to an RSS compatible document. The agent also functions to provide the connectivity between the MMS and the reader in the MMC and to handle requests for documents received from the MMC. The agent also provides the user interface between the user and the MMS. For example, management functions provided by the agent include: (1) checking for authorized access to both the MMS and the RSS documents via username and password as well as (2) emailing credentials to users when the credentials are created.

The agent comprises an IP notification task which functions to monitor the NIC through which the connection by the MMC to the MMS is made. Any changes detected in the WAN IP address of assigned to the NIC are relayed to the authentication server. If a change is detected, the IP notification task is operative to send a change message to the authentication comprising the WAN IP address, MAC address of the NIC card and port number of the MMS server.

The HTTP server module of the MMS provides the capability to the user for web-based viewing/streaming of PC content through a conventional Internet web browser.

The agent has access to the PC hard disk contents 180 and also interfaces with one or more applications 184. The applications have access to the hard disk contents 180 and their associated application data 182 which may be stored on the hard disk 180 or separately.

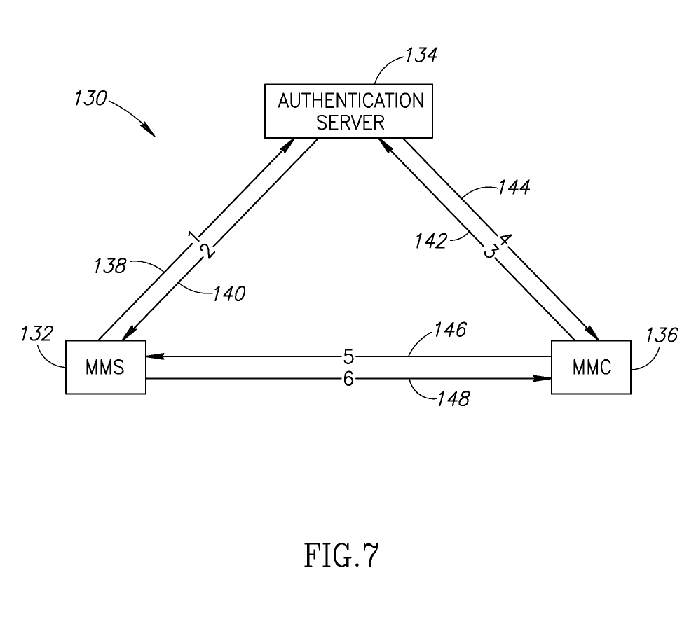

A block diagram illustrating the processing sequence of the RSS based PC content delivery system of the present invention is shown in FIG. 7. The example configuration, generally referenced 130, comprises the authentication server 134, MMS 132 and MMC 136 each in communication with each other. The processing sequence is indicated by the arrows numbered 1 (referenced 138), 2 (referenced 140), 3 (referenced 142), 4 (referenced 144), 5 (referenced 146) and 6 (referenced 148).

With reference to FIGS. 4, 5 and 6, the following provides a description of the processing sequence representing the high level flow of the operation of the RSS based PC content delivery mechanism of the present invention.

Processing Sequence Step 1 (Referenced 138):

The RSS agent application in the MMS on the user's computer communicates its WAN IP address (e.g., the IP address assigned to it by an ISP) to the third party service on the remote authentication server. As described supra, the WAN IP address is sent along with the MAC address of the network interface card (NIC) as well as the port number of the MMS that the application will use to listen for incoming requests from MMCs. The data is encrypted using a standard encryption algorithm and incorporated in a message sent to the authentication server. The authentication server functions to decrypt the message and, using the MAC address as a key, updates a corresponding record in the user information database with the new WAN IP address if a record corresponding to that MMS already exists.

Processing Sequence Step 2 (Referenced 140):

If a record is not in the user information database, the authentication server generates a unique serial number to be associated with the MMS. The authentication server sends the serial number back to the MMS. The MMS stores the serial number for use in authenticating requests from the MMC for RSS documents. Ultimately, the user at the MMC must provide the appropriate serial number corresponding to the MMS desired to receive content from.

Processing Sequence Step 3 (Referenced 142):

When initiated by a user, the MMC in the client computing device contacts the third-party service running on the authentication server using the unique serial number corresponding to the MMS on the user's PC. Note that the serial number and other information were entered into the MMC upon first use along with the username and password of the MMS. In the event that the MMC is a conventional web browser, such credentials can be stored in a medium on the user's hard drive (such as a “cookie”) and transmitted to the MMS for authentication. The authentication server attempts to authenticate and verify the received information.

Processing Sequence Step 4 (Referenced 144):

If the authentication server finds a match and successfully resolves the serial number sent by the MMC, it retrieves the corresponding record from the user information database which comprises the IP address and port number of the MMS associated with that serial number. The IP address and port number are sent back to the MMC.

Processing Sequence Step 5 (Referenced 146):

Having obtained the location of the MMS, the MMC connects to MMS via the Internet using the IP address and port number received from the authentication server. This creates a “peer-to-peer” relationship in which requests sent by the MMC are sent directly to the MMS and not to a third-party or intermediary for translation or processing. The MMC sends the username and password that was entered upon first use along with the serial number associated with that MMS. The MMS on the user's PC resolves, verifies and authenticates the credentials.

Processing Sequence Step 6 (Referenced 148):

The user at the MMC then enters a request (e.g., query, command, etc.) which is relayed to the MMS. In response, the MMS on the user's PC returns the RSS document corresponding to the request. The RSS document is received by the RSS reader in the MMC which functions to process and display the contents of the RSS document. If the document displayed offers further selection, the MMC user selects an item from the document (via any suitable input method). The application forwarder passes the selection to the appropriate application for rendering (i.e. media player for music, video player for video, etc.)

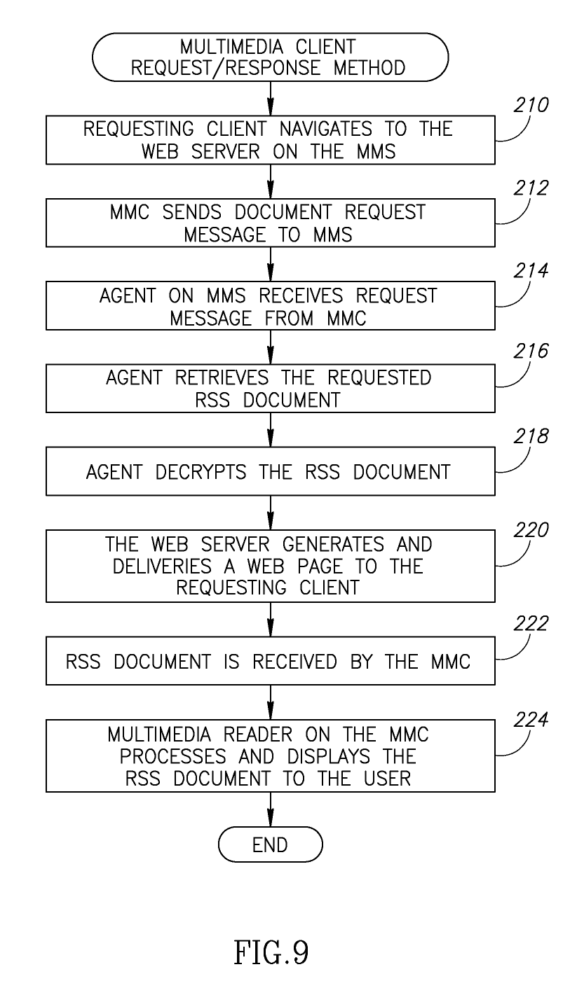

Example uses of the RSS based PC content delivery mechanism of the invention include remote document management and email access. Remote document access permits a user to view word processing documents (e.g., Word, Wordperfect, etc.) located on the user's PC over the network on the client computing device (MMC). The only requirement is that the appropriate word processing document readers are available on the client computing device (MMC). Email access would operate by rendering and displaying the data from the email program (e.g., Microsoft Outlook) and allowing the user to interact with that data through RSS. By rendering the email data as RSS, the user is able to view her/his emails from the client computing device and click on an element (as represented as a link in HTML) which retrieves further information about the email (e.g., the entire body of the email) from the email application as rendered as an RSS element by the MMS. In this case, the emails must be rendered at the MMS into plain text for inclusion into an RSS document before being sent to the MMC. This is achieved by indexing the email with unique ID numbers into an RSS document. A user then clicks on an element allowing the MMS to retrieve the specific, detailed email using that unique ID. This process is described in more detail infra in connection with FIG. 9.

It is important to note that regardless of the application, the mechanism of the invention is operative to render (i.e. convert) into RSS format all data on the user's PC (i.e. the server) that is to be served to the MMC over the network.

### Generation of RSS Documents by the Agent on the MMS

The invention utilizes the really simple syndication (RSS) format to represent documents for delivery to the target or client computing device. Every object that can be identified through a Uniform Resource Identifier (URI) is a resource that can be embedded in an RSS document. An RSS document contains information about which information objects are to be found under a URI. In addition, it can include a description of the resource and the individual information objects, the specification of a unique identifier for the objects and other information. It is also possible that the information object described may be completely embedded in the feed document. In this case, the invention provides a method of generating RSS documents from the application data. This is achieved by indexing the email with unique ID numbers into an RSS document. A user then clicks on an element allowing the MMS to retrieve the specific, detailed email using that unique ID. This process is described in more detail infra in connection with FIG. 9.

All RSS documents are translated into serialized strings of characters and they use existing formats for content, i.e. simple text, HTML, XHTML, other XML vocabularies. RSS works independently of the internal structure of the information. Any item or collection of information can be the object of a RSS document. There are two kinds of information objects in all RSS formats, that is, collections of new information items and new individual items of information. The collections are called a channel (or a feed); an object within a collection is called an item or an entry. Both the channel and the item comprise content information, metadata, and information about the identification and linking of information objects.

An RSS document may describe another web resource, namely, the resource that is identified by the content of the link element. The presence of an element called a link, and with it, the ability to identify a document it refers to, distinguishes RSS documents from other web formats like HTML. The link element only states what the RSS document describes.

One of the characteristics of RSS is that the description is defined very generically making it is possible to include any type of content in the description. Thus, any kind of web content can be sampled and further distributed in an RSS document. This characteristic of RSS is used by the present invention.

In addition, RSS, as a subset of XML, can be “translated” and “stylized” through eXtensible Style Sheet (XSTL) into HTML and thereby consumed by any application capable of rendering HTML content, such as a conventional web browser. This mechanism allows “serialized content” such as RSS to be embedded into an otherwise normal looking webpage and not a list of RSS data elements.

As described supra and with reference to FIG. 6, the RSS agent in the MMS functions to generate the RSS documents that are ultimately served to the MMC. The user at her/his PC can indicate to have the RSS agent analyze any combination of directories and/or files. Some options include: (1) the entire server computer, (2) only certain types of files on their computer, (3) certain directories on their computer, (4) only certain files in certain directories or (5) application data that the user identifies such as contacts or email from a personal information management (PIM) system such as like Microsoft Outlook.

The user interacts with the agent through an interface provided by the agent on the MMS that allows her/him to select a desired type of indexing. Once the user makes a selection of what files or directories are to be rendered into RSS format by the agent, that information is stored in a user configuration database 174 that the agent can access at any time.

Once user configuration information is stored, the agent generates the RSS representation of the selected files, directories or application data (e.g., email from a personal information management such as Microsoft Outlook).

The process of creating the RSS representation of the selected data is as follows: (1) first, the agent reads the directory or file name from the hard disk 180; (2) the agent then writes the directory or file name into an RSS element enclosure such as shown below.

<item>
<title>Name of file or directory</title>
<description>Empty</description>
<enclosure/>c://my documents/documents/work/
document.doc</enclosure>
</item>

Each <item> element created is appended to a single RSS document that is then encrypted by the agent. The encrypted RSS document is then stored in a RSS documents database 176 accessible by the Agent. The RSS documents are encrypted using any well-known encryption algorithm such as RSA, MD5, public/private key, etc.

In the event the desired PC items include application data (e.g., emails within an email application, or other application specific items), the invention provides a mechanism for representing application data as RSS documents. Further, the invention provides a mechanism for the delivery of RSS documents to the multimedia client and for permitting the user at the client device to interact with the RSS document displayed as a web page.

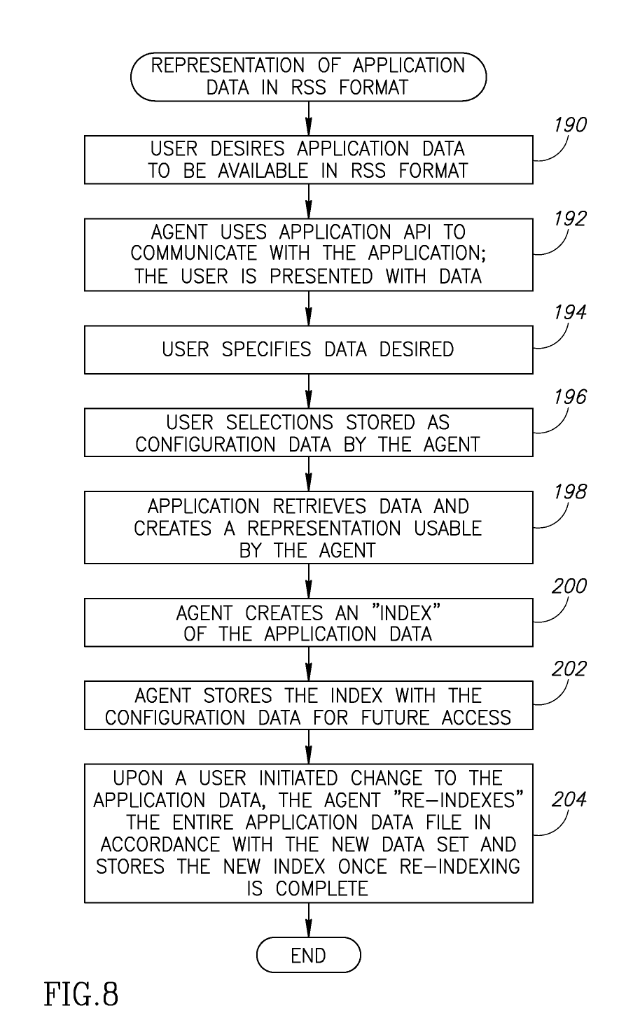

A flow diagram illustrating the method of representing application data in RSS format is shown in FIG. 8. If the user desires the agent to serve application data (such as email or contacts from a personal information management) to the MMC (step 190), the application must have a corresponding method for the agent to connect to the application. This is typically provided in an Application Program Interface or API provided by the manufacture of the application. The API defines how the agent communicates to the application and retrieves the data from the application that was requested by the user. If the application has such an API, the user specifies to the agent that the application data is to be represented in RSS format.

The agent then attempts to communicate with the application using the appropriate API and presents the user with application data (step 192). From the application data presented, the user further specifies the particular data to be available for serving to the MMC (step 194). The data selection can be performed using dialog boxes and other various graphical user interface (GUI) elements.

Once selected, the user's choices (i.e. the data to be served) and any required username, password or other parameters the agent needs to access the data, are stored as configuration data in the user configuration database 174 by the agent for future access (step 196). Note that the data stored in the user configuration database can be stored in either clear text or encrypted text depending on the particular implementation.

Once the configuration data is stored, at some point later in time, the agent retrieves the data from the user configuration database and creates a representation of the data that can be utilized by the agent (step 198). Each application accessed by the agent is assigned a unique ID for identification purposes. This unique ID is stored in a master dataset of applications 178 in any suitable format, such as XML. This master dataset could be represented as the following:

<application>
<name>Name of application</name>
<ID>Unique ID of the application, generated randomly
by the Agent</ID>
<location>Location of application (c:/program files/application
name/application.exe)</location>
<API>Name of API function to call (i.e., getdata( ))</API>
<parameters/>
<parameter1>name of parameter</parameter1>
...
</parameters>
</application>

Note that the number of parameters is not limited. When a request is made by a requesting multimedia client for data (i.e. a user clicks on an element in a web page that corresponds to a request for getting more detailed data from an application), the agent receives the request in the following form:
{application ID}:{element ID}

The ‘application ID’ is used to retrieve the configuration data and other information from the master dataset of applications 178. To retrieve the data, the agent compares all the <ID> tag records in the XML file looking for a match on the ID. The agent then pieces together a command string to the application consisting of the name of the API function and each parameter that exists within the recursive parameter tags. The API function is pulled from the API tag of the appropriate XML record corresponding to that application. The agent then passes this information to the application executable (determined from the location tag within the XML record) and processes the returning data into the RSS document.

When the agent represents the data, the <Item> tag within the RSS document may be modified depending upon the specific requirements of the application data. For example, an email may be represented as the following

<item>
<title>Subject of Email</title>
<description>Synopsis of email text</description>
<datesent>Date Sent</datesent>
<sender>Sender's name</sender>
<enclosure/>{application ID}:{element ID}</enclosure>
</item>

In order to create an ‘index’ of the application data, the agent goes through the entire application data file (based upon the example data presented) and creates a numerical index of the items within the file (step 200). Note that an item represents a complete record of data that the user indicated they wanted to see (i.e. serve to the MMC). This index is stored in the configuration information database 174 in order to permit access to the application data by the agent (step 202).

In the event that the user changes the requirements of the data (i.e. different elements of data from the application are to be served), the agent ‘re-indexes’ the entire application data file according to the new data set and stores the resulting new index in the user configuration database (step 204).

A flow diagram illustrating the request/response method of the multimedia client is shown in FIG. 9. As described supra and with reference to FIG. 6, the MMS comprises an integral web server 186 which functions to serve and present documents to requesting clients (i.e. web browsers), typically through port 80. The agent provides a set of server side application programming interfaces (APIs). These APIs are programs created in languages and methods designed to provide functionality that is processed by the server in response to a request by a client through a web browser. The APIs function to process requests generated by the multimedia client. These requests are initiated by a user through clicking on a link in the web pages served up by the web server 186 and displayed at the MMC.

A user can request information at the MMC by accessing the web server 186 by navigating to its IP address (step 210). The MMC must first obtain the IP address and port number of the MMS by sending a request containing the serial number of the MMS to the authentication server. Note that the IP address of the MMS is the address assigned to the computer, by a router or similar networking component, on which the agent and MMS are located.

Once the IP address and port number are obtained from the authentication server and the MMC has ‘logged into’ the MMS, the MMC generates and sends a document request to the MMS (step 212). The web serve 186 receives the request from the MMC and forwards it to the agent (step 214).

Note that in the event that the computer on which the agent resides has multiple web servers running (e.g., from multiple applications), a unique port number can be used to further narrow the request to the agent. A request to the agent then might be formed as such: http://192.168.1.99:1475 where the number to the right of the colon is the unique port number.

When the request from the multimedia client is received, the agent then searches for the requested RSS document in the RSS document database 176. If found, the agent retrieves the RSS document from the RSS document database (step 216). The agent then decrypts the RSS document using the complementary algorithm used to encrypt the document (step 218). The agent then passes the RSS document to the web server which generates and delivers the web page to the requesting client (step 220). The MMC receives the web page (step 222) and the RSS reader 164 (FIG. 5) and processes and displays the web page to the user (step 224).

The web server 186 is configured to deliver to a requesting client a web page that displays the RSS document. At the MMC, each of the <Items> within the RSS document is displayed as a link on the web page and appropriately stylized through an XSTL style sheet if one is provided to the user through the MMS. When the requesting user clicks on a link in the webpage, a corresponding request is sent to the MMS. The web server receives this request and passes it to the agent. The agent processes the request and retrieves the file or directory associated with the link and rendered as an RSS document and passes the document to the web server 186. The web server, in turn, serves the web page to the requesting client. In the event that the link points to a file, the request may be processed as a “Save This File” response, allowing the requesting user at the MMC to save the file (depending on the computing device and its operating system). In the event that the link a user clicks on represents application data or data points further down the hierarchy of the application (e.g., displaying the full text of an email), a corresponding server side agent task in the MMS processes the corresponding request by searching for data within the application data database 182 associated with the particular application.

Note that all RSS formats are pure source text-based content formats. Thus, the RSS reader in the MMC is operative to determine any necessary additional presentation instructions that must be adapted to the respective presentation medium (i.e. the display, etc.). The presentation instructions allow the reader to present RSS documents in different media or in different contexts. In one example, embodiment, the reader in the MMC is adapted to present the RSS documents by first converting them into HTML and then using a conventional HTML browser or toolkit to display the HTML.

To aid in illustrating the principles of the RSS based PC content delivery mechanism of the present invention, an example application comprising a music player is presented. The content in this item represents an example application built using the technology architecture described hereinabove to stream music files located on a user's PC to a cellular phone having an appropriate music player application installed therein.

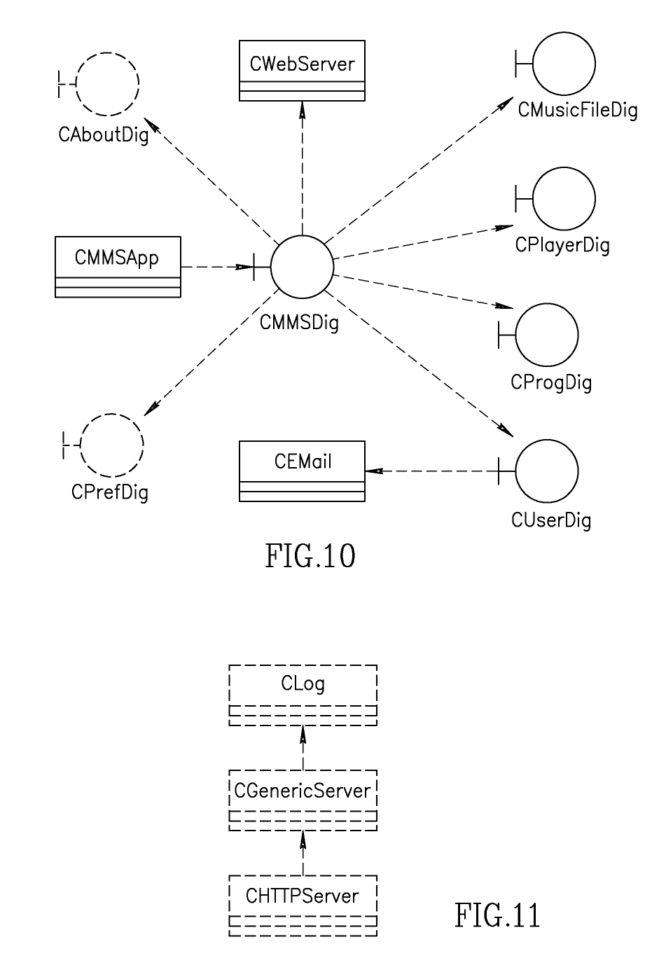

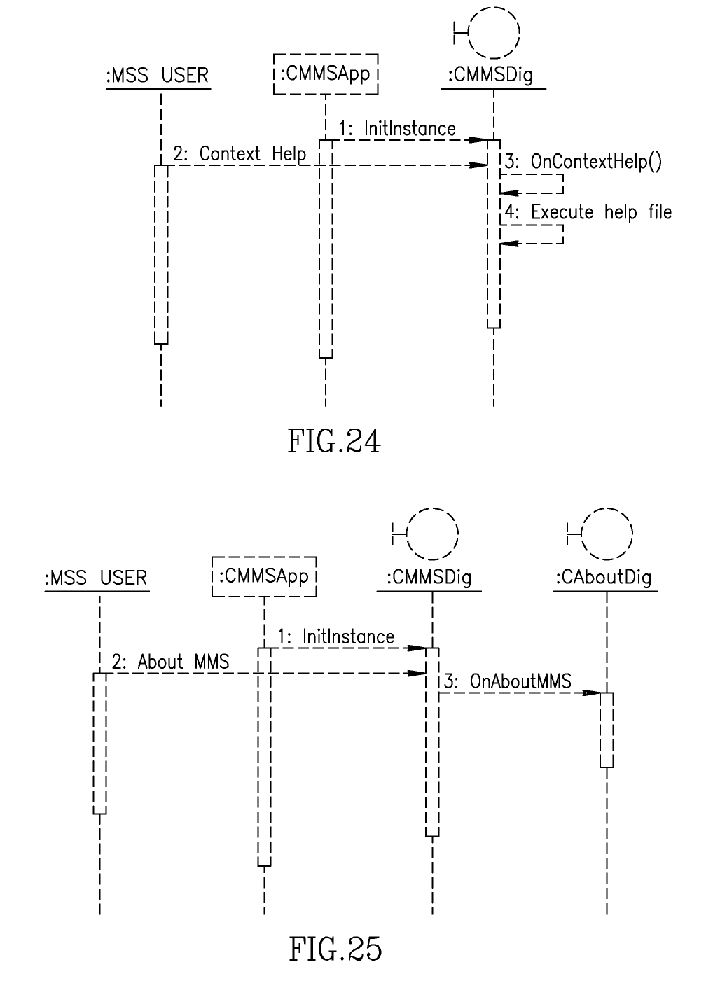

The following description including the numerous class definitions and corresponding FIGS. 10-41, can be used by one skilled in the computer arts to implement an example music player. One skilled in the computer arts can apply the principles presented in this illustrative example, however, to other applications. The example describes the development of a “Mobile Media Streaming” handheld mobile device (e.g., cellular phone). The system comprises four modules: (1) MMS, (2) music application on the server, (3) IP authentication server, and (4) MMC and music player application. Through the music application, the user can create credentials, generate an XML file for audio files and a play list of for the music player, send email and import a play list. Using the reader on the MMC, the user can connect to the MMS and IP authentication server as described supra. The user can also search, stream and play audio files on the mobile device. Although this example application is intended for a mobile device, one skilled in the art can apply it to other computing devices as well.

### Server Based Music Application

The example music application is intended to execute on the server. The following are the main features of the application. A diagram illustrating the logical architecture of the server based music application portion of the example music retrieval system is shown in FIG. 10.

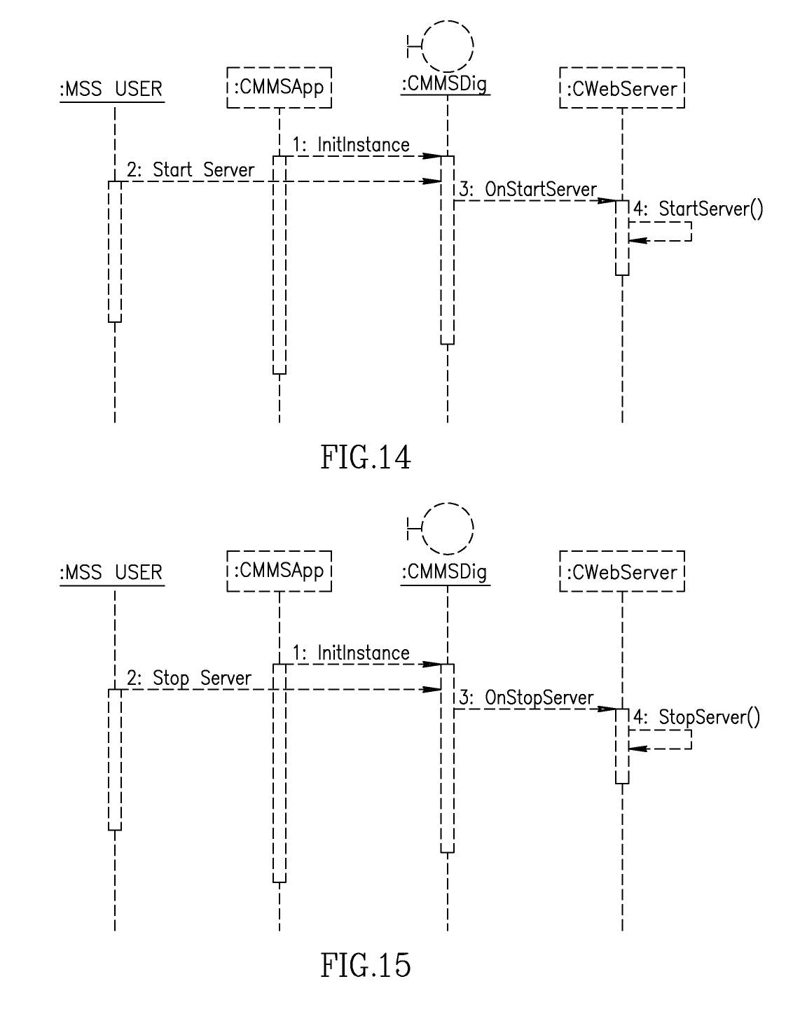

Start Server: This task allows the user to start the MMS from the server music application. A diagram illustrating the sequencing for the Start Server task is shown in FIG. 14.

Stop Server: This task allows the user to stop the MMS from the server music application. A diagram illustrating the sequencing for the Stop Server task is shown in FIG. 15.

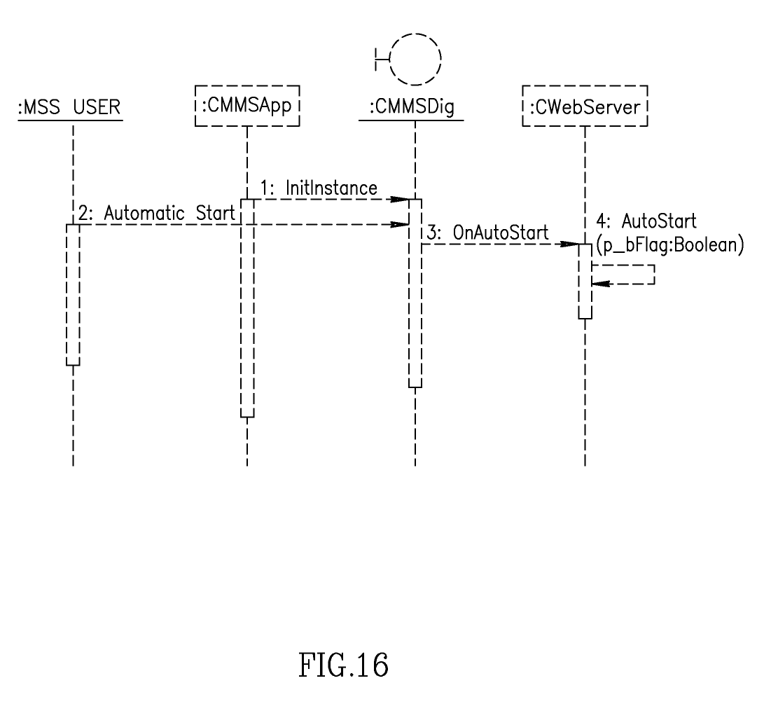

Automatic Start: When the PC is started, the MMS is started automatically. A diagram illustrating the sequencing for Auto Start Server task is shown in FIG. 16.

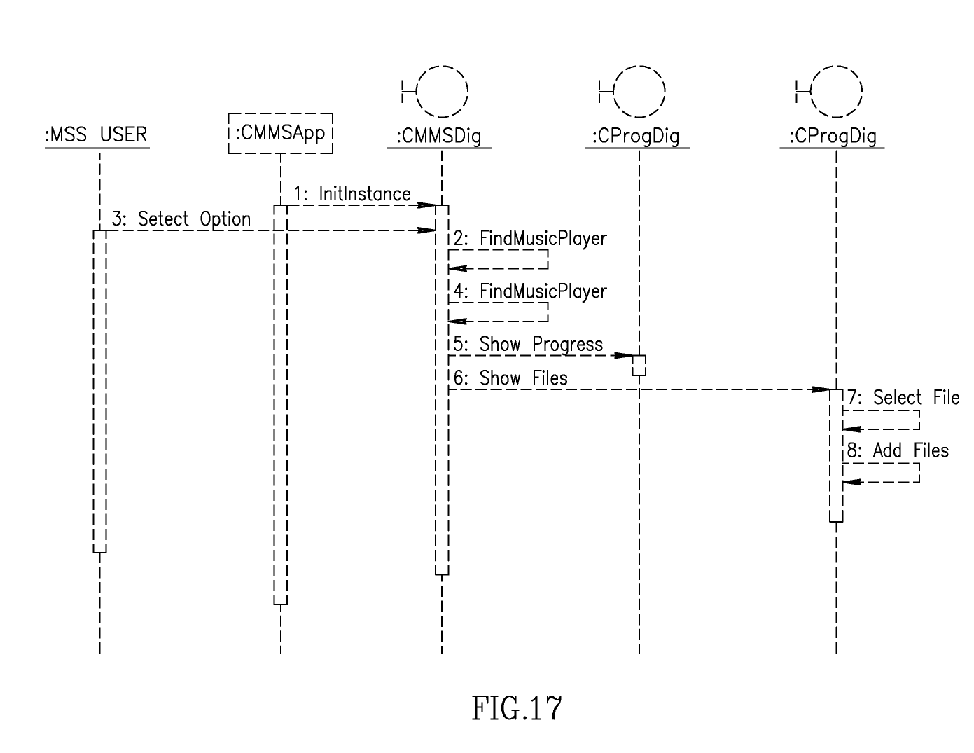

Search Files: Users can search audio files from the audio folder or play list of the music player application installed on the user's PC and generate RSS documents. A diagram illustrating the sequencing for the Search Files task is shown in FIG. 17.

Manage Files: Users can view and delete audio files, which were already added to the RSS document. A diagram illustrating the sequencing for the Manage Files task is shown in FIG. 19.

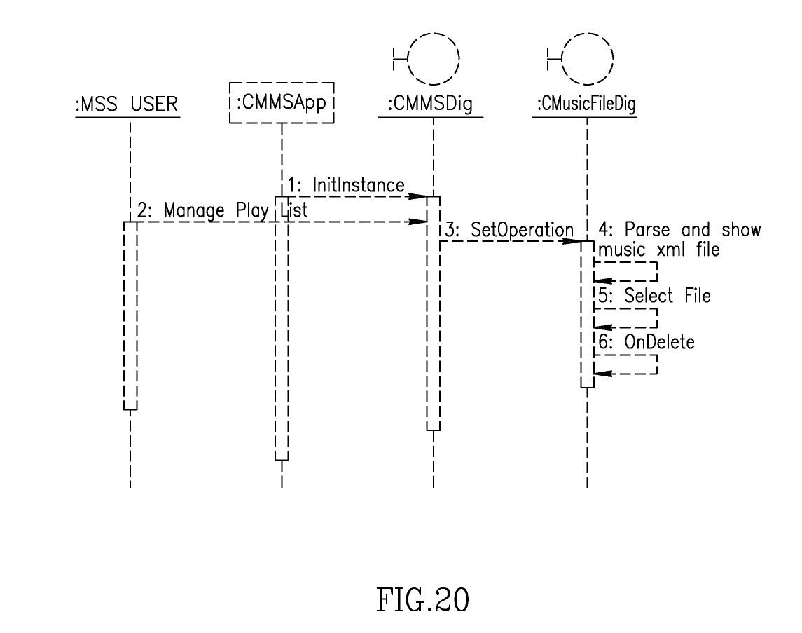

Manage Play List: Users can view and delete audio files, which were already added from the play list of the music player application. A diagram illustrating the sequencing for the Manage Play List task is shown in FIG. 20.

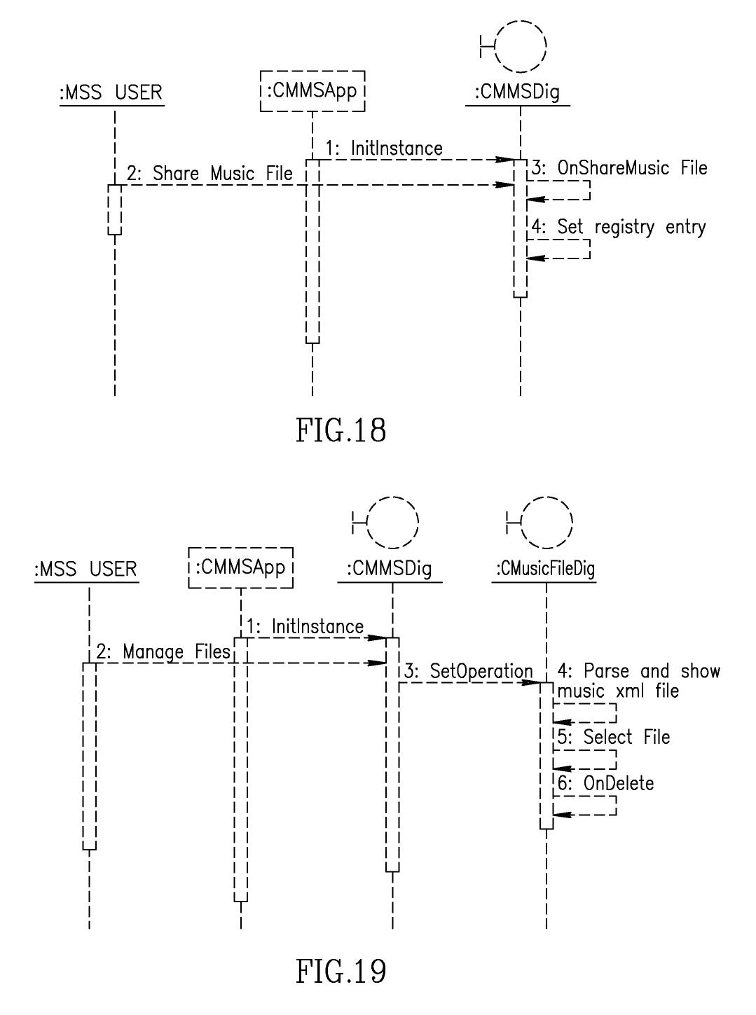

Share Music File: Users can share music files for accessing by the RSS reader in the MMC. A diagram illustrating the sequencing for the Share Music File task is shown in FIG. 18.

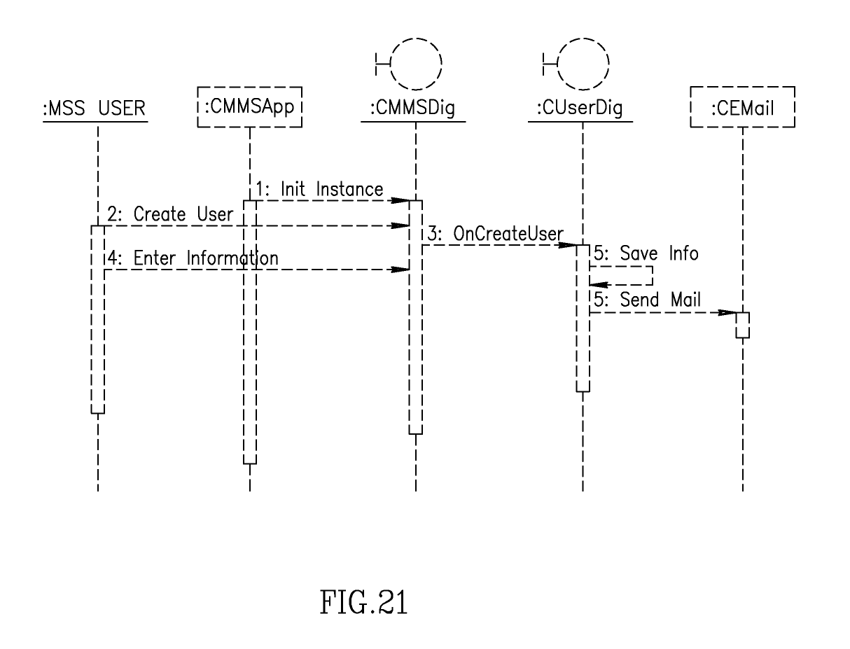

Create User: Users can create credentials for the reader in the MMC and send credential to the MMC user via email. A diagram illustrating the sequencing for the Create User task is shown in FIG. 21.

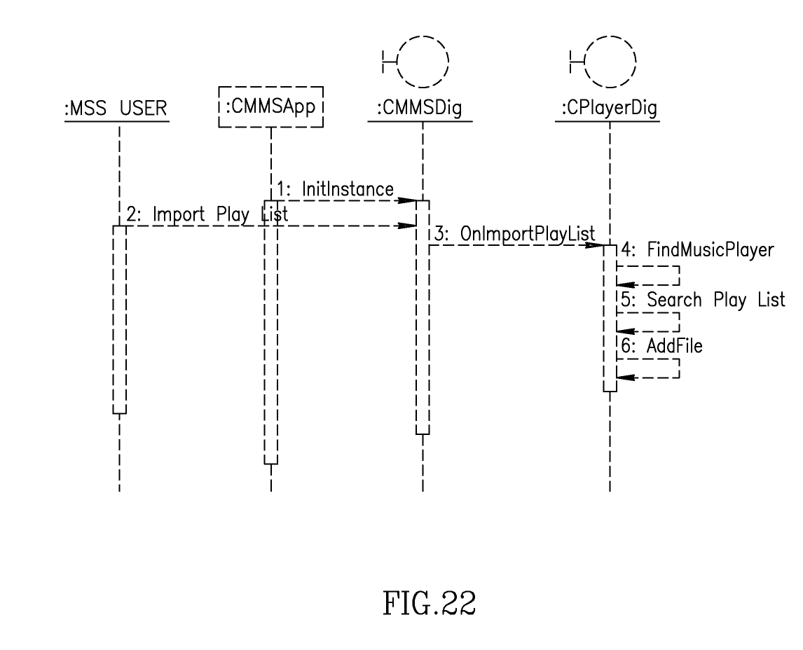

Import Play List: Users can import the entire play list of the music player and add that play list to the RSS document. A diagram illustrating the sequencing for the Import Play List task is shown in FIG. 22.

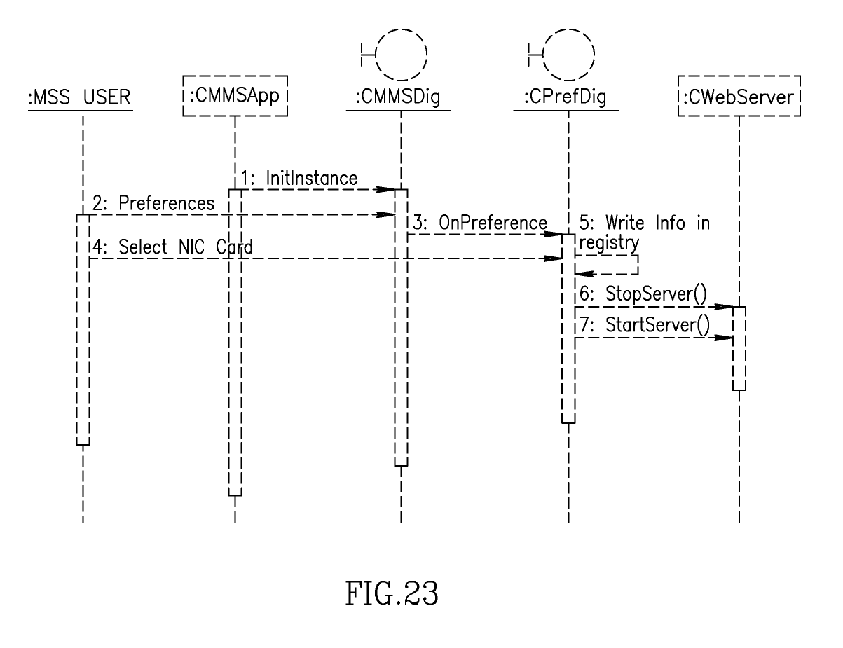

Additional task sequence diagrams are provided for Preferences, Help and About tasks are shown in FIGS. 23, 24, 25, respectively.

### Multimedia Server (MMS)

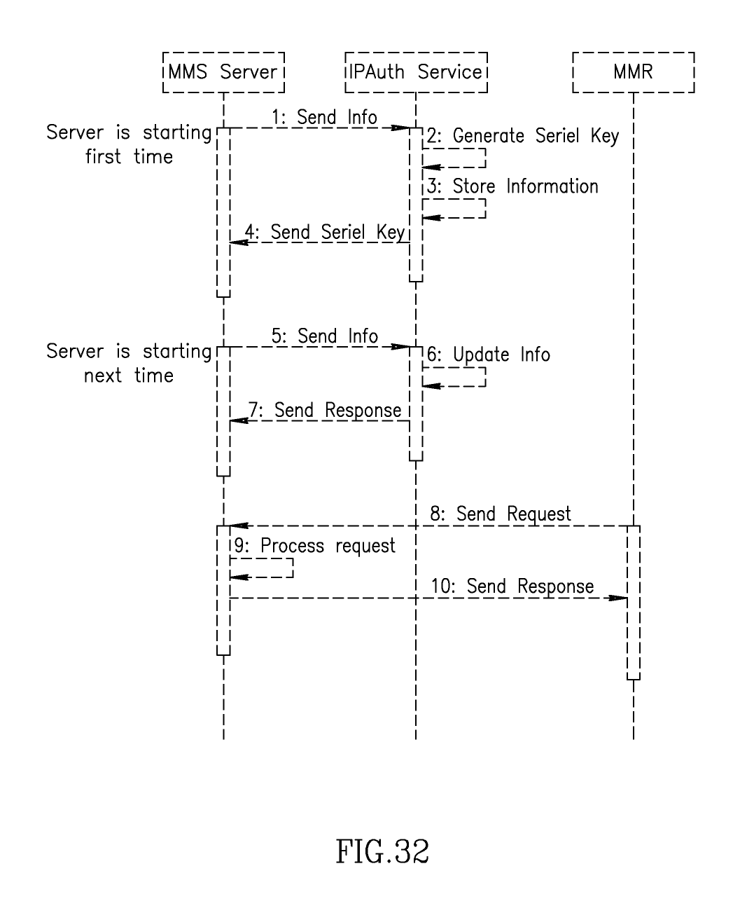

The MMS is intended to execute on the user's PC. Although the operation of the MMS was described in detail supra, the following are highlights of its main features. A diagram illustrating the logical architecture of the MMS server portion of the example music retrieval system is shown in FIG. 11. A diagram illustrating the sequencing for the MMS Server task is shown in FIG. 32.

Send Info to IP Authentication Service: The MMS server sends its information to the IP authentication server which generates a unique serial key. The serial key is sent to the MMS server. The MMS server uses this serial key whenever it sends updated information to the IP authentication server. This server runs on the machine whose IP address is likely dynamic.

Process Request from the MMC: When server receives a request from the MMC it processes that request and sends a response to the MMC.

Update RSS document (i.e. XML file in the case of RSS 2.0): Periodically, the MMS checks the RSS document rendered by the agent and if it finds any changes, the agent updates the document.

### IP Authentication Service

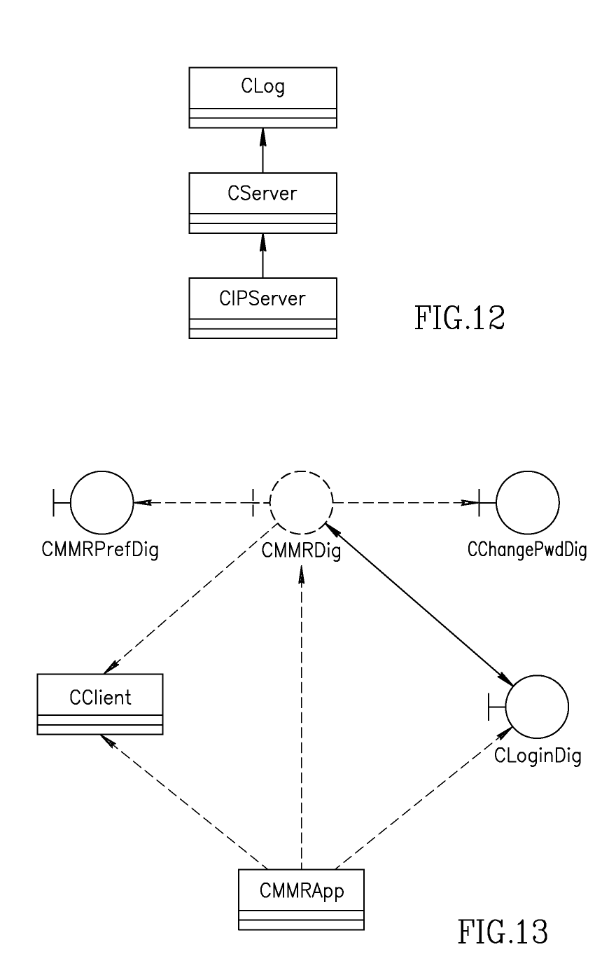

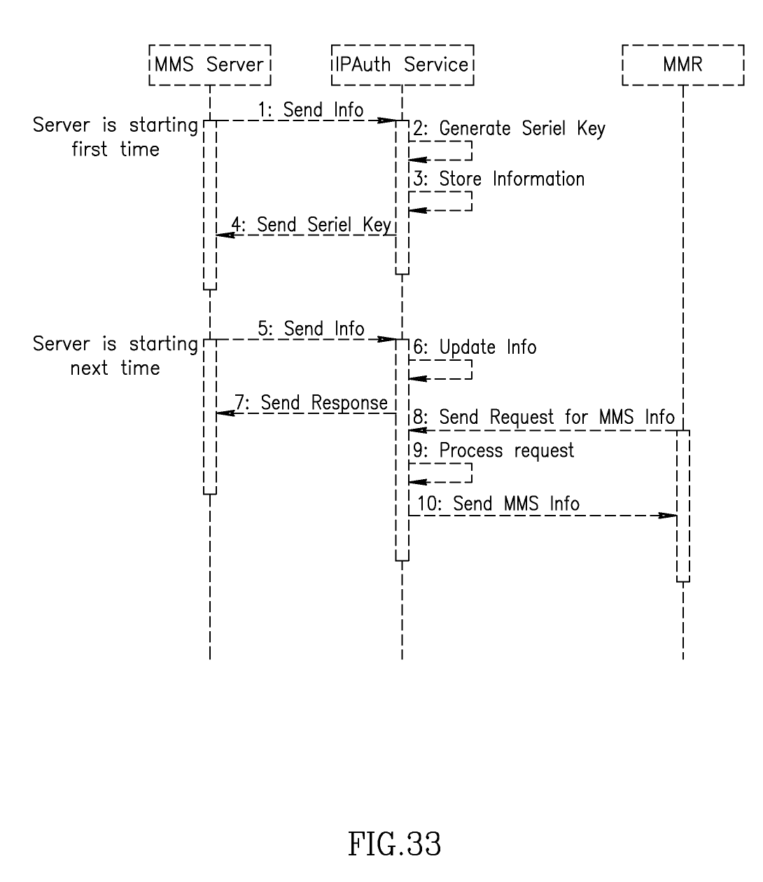

The IP authentication service runs on a remote authentication server. Although the operation of the IP authentication service was described in detail supra, the following are highlights of its main features. A diagram illustrating the logical architecture of the IP authentication server of the example music retrieval system is shown in FIG. 12. A diagram illustrating the sequencing for the IP authentication service task is shown in FIG. 33.

Provide MMS information to the MMC: When the reader in the MMC is started it connects to the IP authentication service and requests the MMS related information in accordance with the unique serial key. The IP authentication service retrieves and sends the MMS related information to the reader in the MMC.

Generate Serial Key: When an MMS server connects to the IP authentication service for the first time, it generates a unique serial number for that MMS server, and stores MMS related information in its MMS user information database.

Update MMS Server Information: Upon receipt of a request to change the MMS information, the IP authentication service updates the information in its MMS user information database accordingly using the serial number as the index key to the database.

### Multimedia Client (MMC)

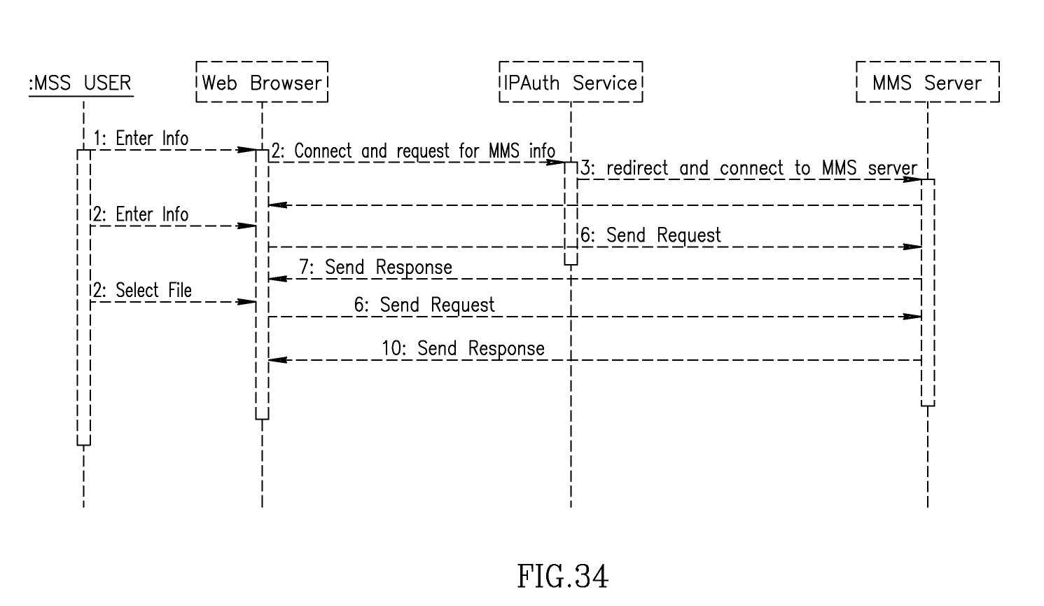

Although the operation of the MMC was described in detail supra, the following are highlights of its main features. A diagram illustrating the logical architecture of the MMC of the example music retrieval system is shown in FIG. 13. A diagram illustrating the overall sequencing for the MMC is shown in FIG. 34.

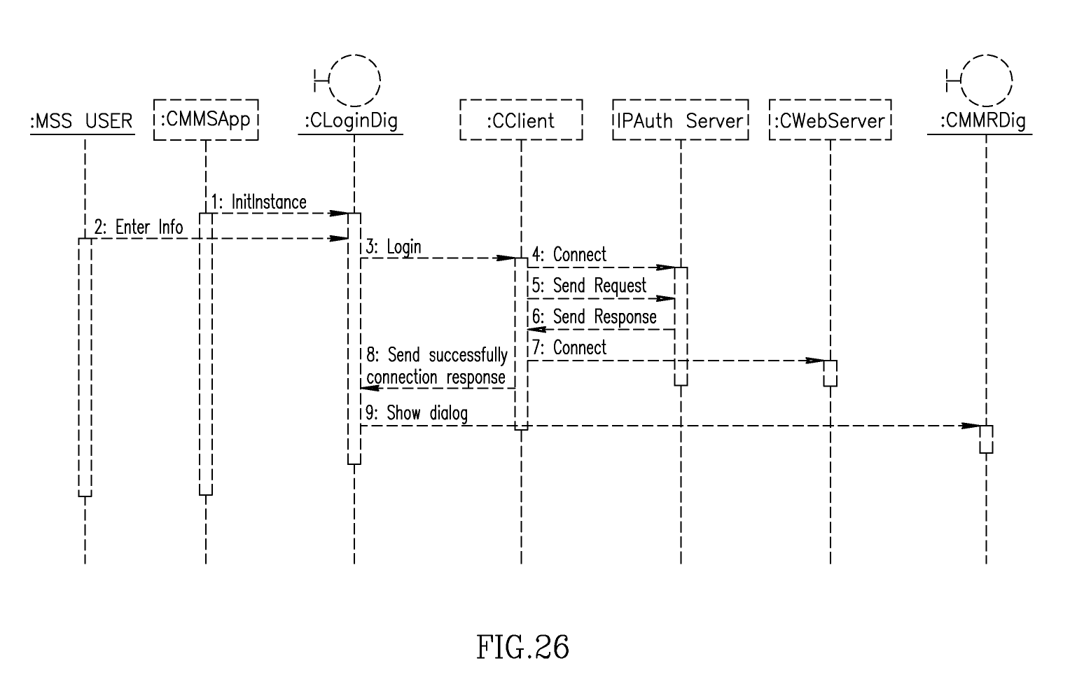

Login: When the MMC is started, the user connects to the MMS server. The user enters a username, password and serial number of the MMS server. The MMC then connects to the IP authentication service and requests the IP address and port number of the MMS server corresponding to the serial key. Once the MMS related information is received, the MMC connects to the MMS server. A user can save login information in a preferences profile for future use and can check options for automatic login when the MMC is started. A diagram illustrating the sequencing for the Login task is shown in FIG. 26.

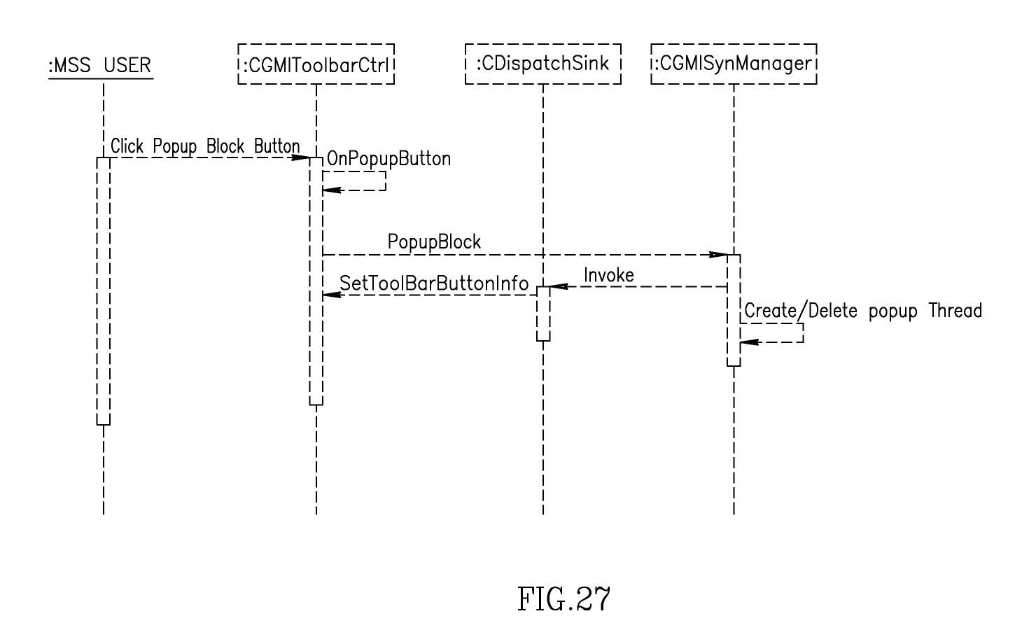

Logout: After finishing work, a user logouts from the MMS server. If the user quits the application without logging out then the user will automatically be logged out from the MMS server. A diagram illustrating the sequencing for the Logout task is shown in FIG. 27.

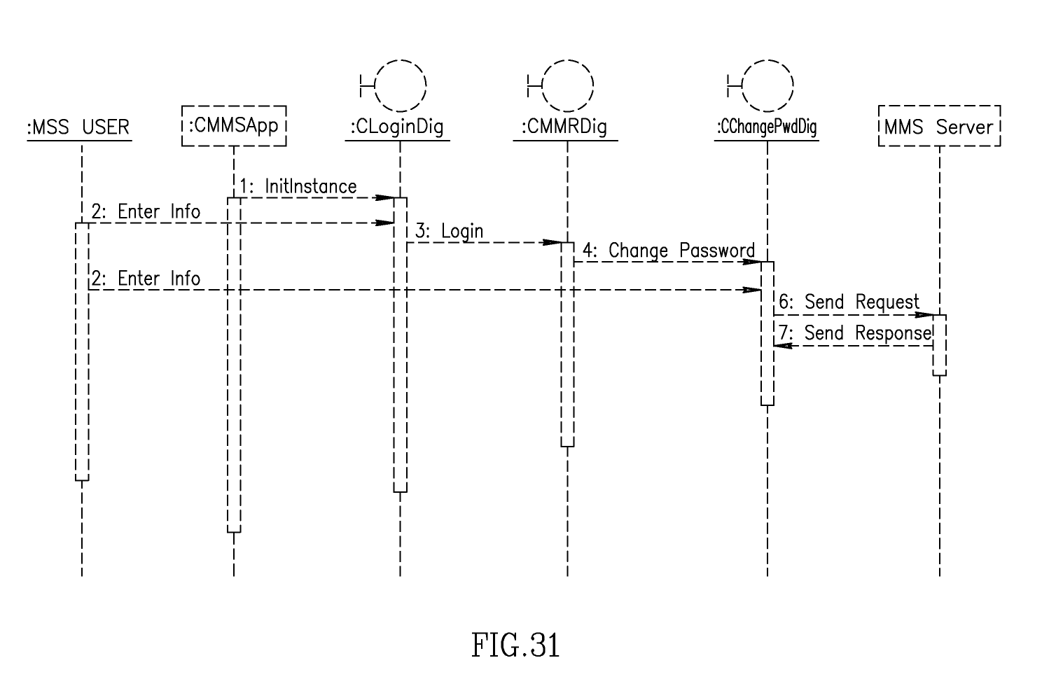

Change Password: Users can change the password. For that user will send a change password request to the MMS server and MMS server will change the password. A diagram illustrating the sequencing for the Change Password task is shown in FIG. 31.

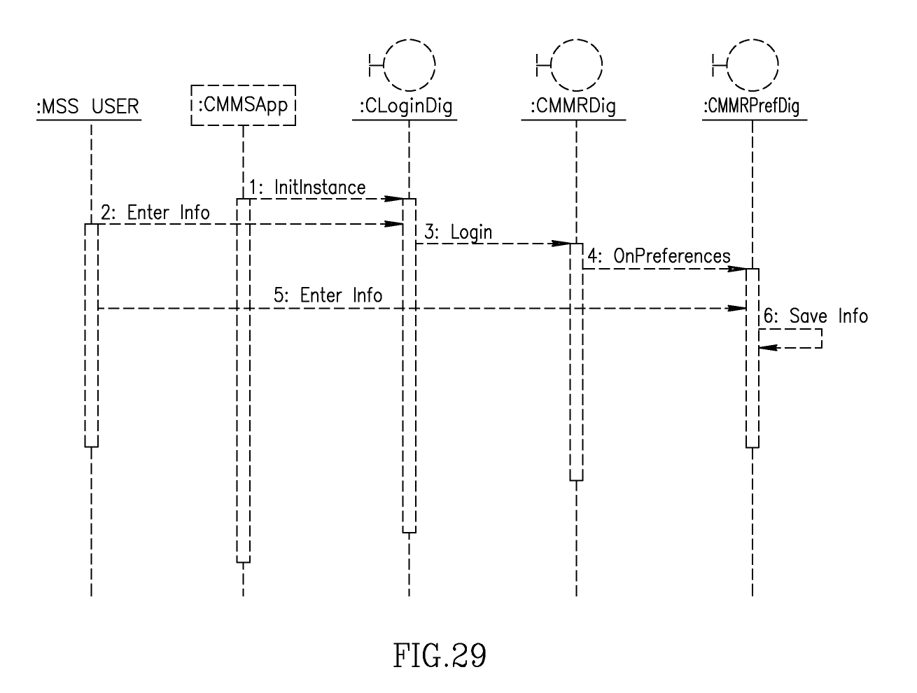

Preferences: Users can change and save information in the preferences for login. A diagram illustrating the sequencing for the Preferences task is shown in FIG. 29.

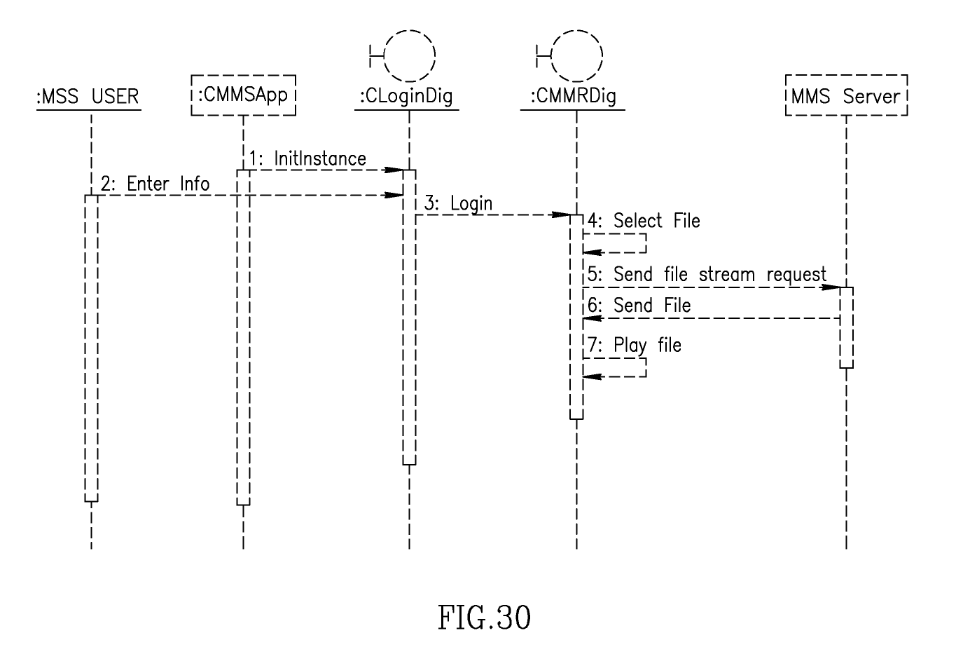

Play: Users can select a file for streaming and play that file on the MMC. A diagram illustrating the sequencing for the Play task is shown in FIG. 30.

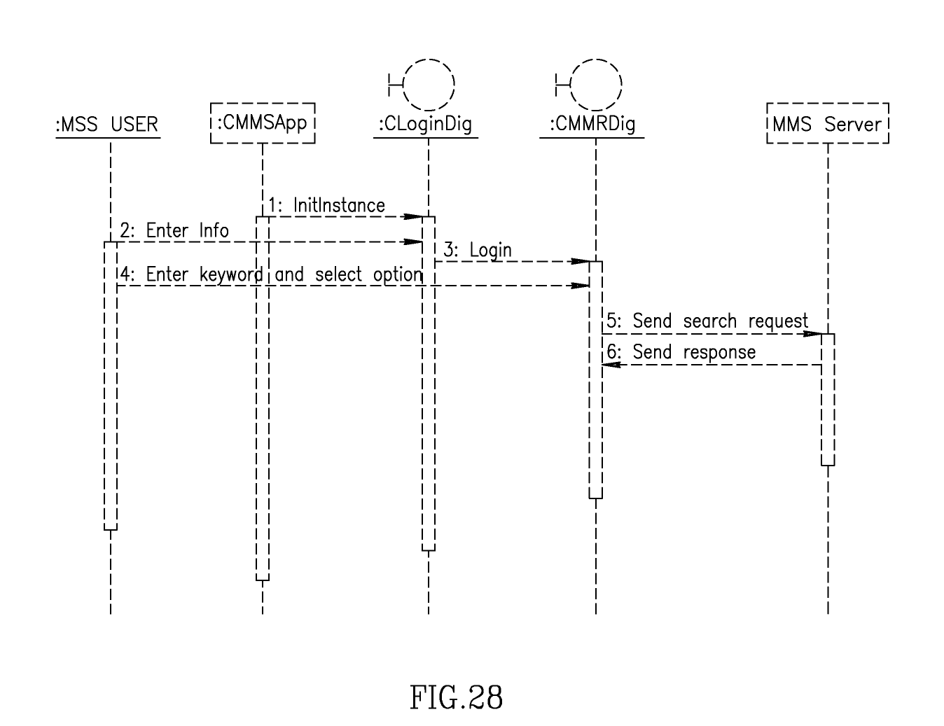

Search: Users can search for songs using the MMS server associated with the MMC. The MMC sends a search request to the MMS server and parses the received response and presents the search results to the user. Users can cancel the search request in the middle of a search. A diagram illustrating the sequencing for the Search task is shown in FIG. 28.

The following are Class definitions used in the implementation of the example music player. Class definitions are provided for the (1) music application running on the MMS (user's PC), (2) the MMS, (3) the IP authentication service and (4) the MMC.

### Music Application Class Definitions

Class Name: CMMSApp

Documentation: This class is derived from CWinApp. The object of this class provides member functions for initializing the application (and each instance of it) and for running the application. When application is executed it shows the main dialog box of the application.

Derived from: CWinApp.

Public Methods:

| | |
|---|---|
| Operation Name | InitInstance |
| Arguments | |
| Return Type | BOOL |
| Documentation | This method instantiated the object of CMMSDlg class |
| | and shows that dialog to the user. |
| Operation Name | CMMSApp |
| Arguments | |
| Return Type | |
| Documentation | This is the default constructor of the class. |

Class Name: CMMSDlg
Documentation: This class is inherited from CDialog. This class provides methods for searching files, create credential, import play list and manage server and XML files.
Derived from: CDialog

Public Properties:

| | |
|---|---|
| Attribute Name | M_bAutoStart |
| Type | BOOL |
| Initial Value | FALSE |
| Documentation | This property is associated with automatic start server on bootup |
| | check box. |
| Attribute Name | M_bShareFile |
| Type | BOOL |
| Initial Value | FALSE |
| Documentation | This property is associated with share music files check box. |
| Attribute Name | M_ctrlMPlayer |
| Type | CcomboBox |
| Initial Value | |
| Documentation | This property is associated with Music Player combo box. |
| Attribute Name | M_strMPlayer |
| Type | CString |
| Initial Value | |
| Documentation | This property is associated with music player combobox. |
| Attribute Name | m_eSearch |
| Type | Enum Esearch |
| Initial Value | PLAY_LIST |
| Documentation | This property is used for searching type of music files. |
| Attribute Name | m_strPlayer |
| Type | CString |
| Initial Value | |
| Documentation | This property is associated with the music player, whose play list has |
| | to search. |
| Attribute Name | m_sFile |
| Type | CSimpleArray<SFile*> |
| Initial Value | |
| Documentation | Used to store the music files information. |
| Attribute Name | m_lCount |
| Type | Long |
| Initial Value | 0 |
| Documentation | Used to count how many music files information is present in the |
| | m_sFile. |

Protected Methods:

| | |
|---|---|
| Operation Name | OnStartServer |
| Arguments | |
| Return Type | Void |
| Documentation | This method starts the MMS server service from windows service |
| | manager using object of CWebServer. |
| Operation Name | OnStopServer |
| Arguments | |
| Return Type | Void |
| Documentation | This method stops the MMS server service from windows service |
| | manager using object of CwebServer. |
| Operation Name | OnAutoStart |
| Arguments | |
| Return Type | Void |
| Documentation | If automatic start server on bootup check box is checked then it sets |
| | entry in the registry and sets automatic start property of the MMS |
| | server service in the windows service manager otherwise clears entry |
| | in the registry and sets the manual start property of the MMS server |
| | service in the windows service manager. This method uses the object |
| | of CwebServer to perform its operation. |
| Operation Name | OnShareFile |
| Arguments | |
| Return Type | Void |
| Documentation | If share music file check box is checked then this method will set |
| | entry in the registry for music file sharing otherwise this will clear |
| | entry in registry. When MMS server will process search file request of |
| | the MMR then server will check for this entry in the registry and |
| | according to that it will process request. |
| Operation Name | OnSearchFiles |
| Arguments | |
| Return Type | Void |
| Documentation | This method will search music files according to option selected and |
| | music player in the combo box. Searching will be performed in the |
| | thread and progress dialog box will be displayed to the user. Thread |
| | will search files according to the option and will populate m_sFile |
| | property and m_lCount. After performing search it will call the |
| | SetOperation method and prompt object of CMusicFileDlg class and |
| | will send m_sFile and m_lCount value to that object. If user press |
| | cancel button of the progress dialog box then object of CprogDlg will |
| | be destroyed and search thread will be terminate. |
| Operation Name | OnManageFile |
| Arguments | |
| Return Type | Void |
| Documentation | Click on the Manage File button of CMMSDlg object will call this |
| | method. This method will call SetOperation method and set value as |
| | MANAGE_FILE, after thatwill prompt the dialog of CmusicFileDlg. |
| Operation Name | OnManagePlayList |
| Arguments | |
| Return Type | Void |
| Documentation | Click on the Manage Play List button of CMMSDlg object will call |
| | this method. This method will call SetOperation method and set value |
| | as MANAGE_PLAY_LIST, after that will prompt the dialog of |
| | CmusicFileDlg. |
| Operation Name | OnCreateUser |
| Arguments | |
| Return Type | Void |
| Documentation | This method will create the object of CuserDlg and will prompt |
| | Create User dialog box. |
| Operation Name | OnImportPlayList |
| Arguments | |
| Return Type | Void |
| Documentation | This method will create the object of CplayerDlg and will show player |
| | dialog box to the user. |
| Operation Name | OnOK |
| Arguments | |
| Return Type | Void |
| Documentation | This method simply closes the dialog box. |
| Operation Name | OnCancel |
| Arguments | |
| Return Type | Void |
| Documentation | This method will close the dialog box. |
| Operation Name | OnPreferences |
| Arguments | |
| Return Type | Void |
| Documentation | Click on this button of the dialog box will create the object of |
| | CprefDlg anf will prompt the preferences dialog box. |
| Operation Name | OnContextHelp |
| Arguments | |
| Return Type | Void |
| Documentation | This method will show the MMS help file. |
| Operation Name | OnAboutMMS |
| Arguments | |
| Return Type | Void |
| Documentation | Click on About MMS menu will create the object of CAboutMMSDlg |
| | and prompt the dialog box. |
| Operation Name | OnContextHelp |
| Arguments | |
| Return Type | Void |
| Documentation | This method will show the MMS help file. |
| Operation Name | OnInitDialog |
| Arguments | |
| Return Type | BOOL |
| Documentation | This method will be called when the object of dialog box will be |
| | going to show. This method will call FindMusicPlayer, ReadValue |
| | and CheckServer method. |
| Operation Name | DoDataExchange |
| Arguments | CdataExchange* pDX |
| Return Type | Void |
| Documentation | This method will exchange the data between controls and its |
| | associated variable. |

Public Methods:

| | |
|---|---|
| Operation Name | FindMusicPlayer |
| Arguments | |
| Return Type | BOOL |
| Documentation | This method will search for music player installed |
| | on the PC and will populate that information in the |
| | combo box. |
| Operation Name | SearchThread |
| Arguments | LPVOID p_pParam |
| Return Type | static UINT_stdcall |
| Documentation | This method will search for audio files or play list |
| | of music player and will populate that information in |
| | the m_sFile and m_lCount properties, which are |
| | the members of CMMSDlg class. |

Private Methods:

| | |
|---|---|
| Operation Name | AddFiles |
| Arguments | |
| Return Type | BOOL |
| Documentation | This method will add music file's information, which is stored in the |
| | m_sFile and m_lCount properties in the XML file corresponding to |
| | value stored in m_eSearch property. |
| Operation Name | ReadValue |
| Arguments | |
| Return Type | BOOL |
| Documentation | This method will read the registry entry for automatic start server on |
| | bootup check box and share music file check box and update the value |
| | of corresponding data members. |
| Operation Name | CheckServer |
| Arguments | |
| Return Type | BOOL |
| Documentation | This method will check whether the MMS server is running or not |
| | from the windows service manager. If it will return true then Start |
| | Server button will be disabled and Stop Server button will be enabled |
| | and if it will return false then Start server button will be enabled and |
| | Stop Server button will be disabled. |

Class Name: CWebServer
Documentation: This class implements methods for managing MMS server.
Derived from:
Public Properties:
Protected Properties:
Private Properties:

Public Methods:

| | |
|---|---|
| Operation Name | CWebServer |
| Arguments | |
| Return Type | |
| Documentation | This is a constructor of this class. |
| Operation Name | ˜CWebServer (virtual) |
| Arguments | |
| Return Type | |
| Documentation | This is a destructor of this class. |
| Operation Name | StartServer |
| Arguments | |
| Return Type | BOOL |
| Documentation | This method sets the start service property in the windows service |
| | manager for MMS server service. |
| Operation Name | StopServer |
| Arguments | |
| Return Type | void |
| Documentation | This method sets the stop service property in the windows service |
| | manager for MMS server service. |
| Operation Name | AutoStart |
| Arguments | BOOL p_bFlag |
| Return Type | BOOL |
| Documentation | If the value of p_bFlag is true then this methods sets the automatic |
| | start property of the MMS server service otherwise will set manual |
| | property. |
| Operation Name | GetIPAddress |
| Arguments | |
| Return Type | CString |
| Documentation | This method gets the IP address where MMS server is running. |
| Operation Name | GetPortNumber |
| Arguments | |
| Return Type | long |
| Documentation | This method gets the port number of the MMS server. |

Protected Methods:
Private Methods:
Class Name: CAboutMMSDlg
Documentation: The object of this depicts the copyright and version info about the MMS System.
Derived from: CDialog
Protected Properties:
Public Properties:
Private Properties:
Public Methods:

Protected Methods:

| | |
|---|---|
| Operation Name | OnOK |
| Arguments | |
| Return Type | Void |
| Documentation | This method closes the dialog box. |

Private Methods:
Class Name: CMusicFileDlg
Documentation: This class provides the methods to show the search result as well as view, add and delete the music file in XML file.
Derived from: CDialog

Public Properties:

| | |
|---|---|
| Attribute Name | m_bSelect |
| Type | BOOL |
| Initial Value | FALSE |
| Documentation | This data member is associated with Select All |
| | check box. |
| Attribute Name | m_ctrlGrid |
| Type | CMSHFlexGrid |
| Initial Value | |
| Documentation | This data members is associated with grid control. |

Protected Properties:

Private Properties:

| | |
|---|---|
| Attribute Name | m_eOPType |
| Type | enum EOPType |
| Initial Value | |
| Documentation | This data member describes that which type |
| | of operation has to perform by the object of its class. |
| Attribute Name | m_psFile |
| Type | CSimpleArray<SFile*>* |
| Initial Value | |
| Documentation | This data member holds the address of the |
| | buffer where searched music file is stored. |
| Attribute Name | m_lCount |
| Type | long |
| Initial Value | 0 |
| Documentation | This property holds the no of files available in |
| | the m_psFile buffer. |

Protected Methods:

| | |
|---|---|
| Operation Name | OnDelete |
| Arguments | |
| Return Type | void |
| Documentation | This method deletes the selected items from the XML file. |
| Operation Name | OnAdd |
| Arguments | |
| Return Type | void |
| Documentation | This method adds the selected items in the XMl file. |
| Operation Name | OnSelectAll |
| Arguments | |
| Return Type | void |
| Documentation | If Select All check box will be checked then this method will select all |
| | items in the grid control and if check box is not checked then it will |
| | deselect all the items in the grid control. |
| Operation Name | OnCancel |
| Arguments | |
| Return Type | void |
| Documentation | This method will close the dialog box. |
| Operation Name | DoDataExchange |
| Arguments | CdataExchange* pDX |
| Return Type | void |
| Documentation | This methods exchanges data between controls and its associated data |
| | member. |
| Operation Name | onInitDialog |
| Arguments | |
| Return Type | BOOL |
| Documentation | This method will be called when dialog box is going to show. It will |
| | call ShowData method. |

Public Methods:

| | |
|---|---|
| Operation Name | SetOperation |
| Arguments | enum EOPType p_eOPType |
| Return Type | void |
| Documentation | This method sets the Operation type performed |
| | by the object means add data |
| | or delete data to/from the XML file. |
| Operation Name | SetData |
| Arguments | CSimpleArray<SFile*>* p_psFile, long p_lCount |
| Return Type | void |
| Documentation | This method will set the searched music file's info to |
| | its data members. |
| Operation Name | ShowData |
| Arguments | |
| Return Type | void |
| Documentation | This method will show the music file info in |
| | the grid control. |

Private Methods:
Class Name: CPlayerDlg
Documentation: This class provides all information of the music player installed on the PC to the user.
Derived from: CDialog

Public Properties:

| | |
|---|---|
| Attribute Name | m_ctrlPlayer |
| Type | ClistBox |
| Initial Value | |
| Documentation | This member is associated with list box |
| | control as control category. |
| Attribute Name | m_strPlayer |
| Type | CString |
| Initial Value | |
| Documentation | This member is associated with list box |
| | control as value category. |

Protected Properties:
Private Properties:

Public Methods:

| | |
|---|---|
| Operation Name | FindMusicPlayer |
| Arguments | |
| Return Type | BOOL |
| Documentation | This method searches all the music player installed |
| | on the PC and shows that in the list box control. |

Protected Methods:

| | |
|---|---|
| Operation Name | OnOK |
| Arguments | |
| Return Type | void |
| Documentation | This method closes the dialog box. |
| Operation Name | OnCancel |
| Arguments | |
| Return Type | void |
| Documentation | This method closes the dialog box. |
| Operation Name | DoDataExchange |
| Arguments | CdataExchange* pDX |
| Return Type | void |
| Documentation | This method exchanges data between controls and |
| | its associated data members. |
| Operation Name | OnInitDialog |
| Arguments | |
| Return Type | BOOL |
| Documentation | This method calls when dialog box is going to |
| | show and call FindMusicPlayer function. |

Private Methods:
Class Name: CProgDlg
Documentation: The object of this class shows the progress bar when searching is in progress.
Derived from: CDialog

Public Properties:

| | |
|---|---|
| Attribute Name | m_ctrlProg |
| Type | CprogressCtrl |
| Initial Value | |
| Documentation | This member is associated with progress bar control. |

Protected Properties:
Private Properties:

Protected Methods:

| | |
|---|---|
| Operation Name | OnInitDialog |
| Arguments | |
| Return Type | BOOL |
| Documentation | This method executes when dialog box is going to |
| | show and sets the timer for progress bar. |
| Operation Name | DoDataExchange |
| Arguments | CdataExchange* pDX |
| Return Type | Void |
| Documentation | This method exchanges data between controls and |
| | its associated data members. |
| Operation Name | OnCancel |
| Arguments | |
| Return Type | void |
| Documentation | This method closes the dialog box. |

Public Methods:
Private Methods:
Class Name: CUserDlg
Documentation: this class provides functionalities for creating userid and send userid's information to its user.
Derived from: CDialog

Public Properties:

| | |
|---|---|
| Attribute Name | m_struserID |
| Type | CString |
| Initial Value | |
| Documentation | This member is associated with userid edit box. |
| Attribute Name | m_strPwd |
| Type | CString |
| Initial Value | |
| Documentation | This member is associated with password edit box. |
| Attribute Name | m_strCPwd |
| Type | CString |
| Initial Value | |
| Documentation | This member is associated with confirm password |
| | edit box. |
| Attribute Name | M_strIMEI |
| Type | CString |
| Initial Value | |
| Documentation | This member is associated with IMEI Number edit box. |
| Attribute Name | M_strMobNo |
| Type | CString |
| Initial Value | |
| Documentation | This member is associated with Mobile Number edit box. |
| Attribute Name | m_strEMail |
| Type | CString |
| Initial Value | |
| Documentation | This member is associated with E-Mail edit box. |
| Attribute Name | m_bSend |
| Type | BOOL |
| Initial Value | TRUE |
| Documentation | This member is associated with send email check box. |

Protected Properties:
Private Properties:

Protected Methods:

| | |
|---|---|
| Operation Name | OnInitDialog |
| Arguments | |
| Return Type | BOOL |
| Documentation | This method gets executed when dialog box is going to create. |
| Operation Name | DoDataExchange |
| Arguments | CDataExchange* pDX |
| Return Type | Void |
| Documentation | This method exchanges the data between controls and its associated |
| | data members. |
| Operation Name | OnCreate |
| Arguments | |
| Return Type | Void |
| Documentation | This method takes the values from the controls and creates userid. |
| | Before creating it checks whether that user id is exist in the user info |
| | file, if it doesn't exist then it will create otherwise not. If Send Mail |
| | check box is checked then it will send userid's info the user by email. |
| | Any one field can not be blank in the dialog box. |

Public Methods:
Private Methods:
Class Name: CEmail
Documentation: This class provides sending email functionality.
Derived from:
Public Properties:
Protected Properties:
Private Properties:

Public Methods:

| | |
|---|---|
| Operation Name | SendMail |
| Arguments | CString p_strMailID, CString p_strSubject, |
| | CString p_strMsg |
| Return Type | BOOL |
| Documentation | This method sends the email. |

Protected Methods:
Private Methods:
Class Name: CPrefDlg
Documentation: This class provides functionality to choose and save the IP address and port number where MMS server will be running.
Derived from: CDialog

Public Properties:

| | |
|---|---|
| Attribute Name | m_strIPAdd |
| Type | CString |
| Initial Value | |
| Documentation | This data member is associated with IP address edit box. |
| Attribute Name | m_strCard |
| Type | CString |
| Initial Value | |
| Documentation | This data member is associated with Card number |
| | edit box. |
| Attribute Name | m_strPortNo |
| Type | CString |
| Initial Value | |
| Documentation | This data member is associated with disable |
| | Port Number edit box. |
| Attribute Name | m_strNewPortNo |
| Type | CString |
| Initial Value | |
| Documentation | This data member is associated with |
| | enable Port Number edit box. |
| Attribute Name | m_ctrlCard |
| Type | ClistBox |
| Initial Value | |
| Documentation | This property is associated with NIC Card List box. |

Protected Properties:
Private Properties:

Public Methods:

| | |
|---|---|
| Operation Name | FindNICCard |
| Arguments | |
| Return Type | BOOL |
| Documentation | This method searches NIC card installed on the PC |
| | and shows that information in list box. |
| Operation Name | ReadValue |
| Arguments | |
| Return Type | BOOL |
| Documentation | This method reads the value of IP address, Port |
| | Number and NIC card number from the registry and |
| | shows it in the dialog box. |
| Operation Name | WriteValue |
| Arguments | |
| Return Type | BOOL |
| Documentation | This method writes the IP address, port number and |
| | NIC card number where MMS server will be running |
| | in the registry. |

Protected Methods:

| | |
|---|---|
| Operation Name | OnCancel |
| Arguments | |
| Return Type | void |
| Documentation | This method simply closes the dialog box. |
| Operation Name | DoDataExchange |
| Arguments | CdataExchange* pDX |
| Return Type | void |
| Documentation | This method exchanges the data between controls and |
| | its associated data members. |
| Operation Name | OnInitDialog |
| Arguments | |
| Return Type | BOOL |
| Documentation | This method executes when dialog box is going to |
| | show and calls ReadValue and FindNICCard method. |
| Operation Name | OnOK |
| Arguments | |
| Return Type | void |
| Documentation | This method save selected NIC card info and port |
| | number in the registry and close the dialog box. |

Private Methods:

### Multimedia Server (MMS) Class Definitions

Class Name: CLog

Documentation: This class provides functionalities for writing log file and clear it.

Derived from:

Private Properties:

| | |
|---|---|
| Attribute Name | m_lTime |
| Type | long |
| Initial Value | 0 |
| Documentation | This data member holds the time when new event is |
| | going to logged in the file. |
| Attribute Name | m_pf |
| Type | FILE* |
| Initial Value | |
| Documentation | This data member holds the pointer of log file. |
| Attribute Name | m_pnewtime |
| Type | struct time* |
| Initial Value | |
| Documentation | This data member holds the event time in GMT format. |
| Attribute Name | m_szDT[128] |
| Type | char |
| Initial Value | “” |
| Documentation | This member holds the event time in formatted string. |
| Attribute Name | m_szLogFilePath[MAX_PATH] |
| Type | char |
| Initial Value | “” |
| Documentation | This member holds the path of the log file. |
| Attribute Name | m_cs |
| Type | CRITICAL_SECTION |
| Initial Value | |
| Documentation | This member is used for thread synchronization. |
| Attribute Name | m_szMessage[MAX_MSG_SIZE] |
| Type | char |
| Initial Value | |
| Documentation | this member holds the message which has to logged. |
| | MAX_MSG_SIZE macro is defined as 1024. |

Protected Properties:
Public Properties:

Public Methods:

| | |
|---|---|
| Operation Name | CLog |
| Arguments | |
| Return Type | |
| Documentation | This is the default constructor of the class, which |
| | initializes the critical section. |
| Operation Name | ˜CLog |
| Arguments | |
| Return Type | |
| Documentation | This is the destructor of the class which delete |
| | critical section. |
| Operation Name | LogMessage |
| Arguments | const char* p_pszFolder, const char* p_pszMsg, |
| | const char* p_pszMsg1, long p_lNumber |
| Return Type | BOOL |
| Documentation | This method logs the message in the log file. |
| Operation Name | ClearLog |
| Arguments | const char*p_pszFolder |
| Return Type | BOOL |
| Documentation | This method clears the log file. |

Protected Methods:
Private Methods:
Class Name: CGenericServer
Documentation: This class creates the client thread, helper thread and provides way to connect multiple clients to the web server.
Derived from: CLog
Public Properties:

Protected Properties:

| | |
|---|---|
| Attribute Name | m_Visitors |
| Type | STRVECT |
| Initial Value | |
| Documentation | This members shows all the clients currently |
| | connected to the MMS server. |

Private Properties:

| | |
|---|---|
| Attribute Name | m_cs |
| Type | CRITICAL_SECTION |
| Initial Value | |
| Documentation | This member is used for thread synchronization. |
| Attribute Name | m_cs1 |
| Type | CRITICAL_SECTION |
| Initial Value | |
| Documentation | This member is used for thread synchronization. |
| Attribute Name | m_bRun |
| Type | BOOL |
| Initial Value | |
| Documentation | This member indicates whether server is running or not. |
| Attribute Name | m_HandleList |
| Type | HANDLELIST |
| Initial Value | |
| Documentation | This member holds the list of all handle of client thread, |
| | when server is going to shutdown it closes all the |
| | handle then will be stop. |
| Attribute Name | m_iPersistenceTo |
| Type | int |
| Initial Value | |
| Documentation | This member holds the timeout value. |
| Attribute Name | m_iServerPort |
| Type | int |
| Initial Value | |
| Documentation | This member has the port number where MMS server |
| | will be running. |
| Attribute Name | m_ShutdownEvent |
| Type | WSAEVENT |
| Initial Value | |
| Documentation | This member indicates the shutdown event's value. |
| Attribute Name | m_Stats |
| Type | StatisticsTag |
| Initial Value | |
| Documentation | This is the structure variable which holds all the |
| | information for the server. |
| Attribute Name | m_ThreadA |
| Type | HANDLE |
| Initial Value | |
| Documentation | This is the handle value of the thread. |
| Attribute Name | m_uiThreadA_ID |
| Type | unsigned int |
| Initial Value | |
| Documentation | This member holds the thread ID. |
| Attribute Name | m_ThreadC |
| Type | HANDLE |
| Initial Value | |
| Documentation | This is the handle value of the thread. |
| Attribute Name | m_uiThreadC_ID |
| Type | unsigned int |
| Initial Value | |
| Documentation | This member holds the thread ID. |
| Attribute Name | m_ThreadLaunchedEvent |
| Type | HANDLE |
| Initial Value | |
| Documentation | This member holds the handle value of event when |
| | thread is going to create. |
| Attribute Name | m_ThreadList |
| Type | THREADLIST |
| Initial Value | |
| Documentation | This data member holds the list of all thread. |
| Attribute Name | m_WaitForCloseEvent |
| Type | HANDLE |
| Initial Value | |
| Documentation | This data member holds the handle value of close event. |

Public Methods:

| | |
|---|---|
| Operation Name | GetLocalAddress |
| Arguments | LPSTR p_lpStr, LPDWORD p_lpdwStrlen |
| Return Type | Int |
| Documentation | This method gets the IP address of the system on |
| | which server is running. |
| Operation Name | GetStats |
| Arguments | StatisticsTag& p_st |
| Return Type | void |
| Documentation | This method gets the statistics of the server. |
| Operation Name | Reset |
| Arguments | |
| Return Type | void |
| Documentation | This method resets the stats value. |
| Operation Name | Run |
| Arguments | CString p_strIPAdd, int p_iPort, int p_iPersTo |
| Return Type | BOOL |
| Documentation | This method starts the server on specified IP address, |
| | port number and sets timeout for that. |
| Operation Name | ShutDown |
| Arguments | |
| Return Type | BOOL |
| Documentation | This method stops the running MMS server. |

Protected Methods:

| | |
|---|---|
| Operation Name | virtual IsComplete = 0 |
| Arguments | |
| Return Type | string p_szRequest |
| Documentation | This method checks whether received request is |
| | complete or partial. |
| Operation Name | virtual ParseRequest = 0 |
| Arguments | string p_szRequest, string p_szResponse, BOOL& |
| | p_bKeepAlive |
| Return Type | BOOL |
| Documentation | This method parse the request and process that. |
| Operation Name | virtual GotConnection = 0 |
| Arguments | const char *p_szChar, int p_iCount |
| Return Type | int |
| Documentation | This method receive connection. |

Private Methods:

| | |
|---|---|
| Operation Name | static_stdcall AcceptThread |
| Arguments | LPVOID p_pParam |
| Return Type | UINT |
| Documentation | This thread accept client's connection request. |
| Operation Name | static_stdcall ClientThread |
| Arguments | LPVOID p_pParam |
| Return Type | UINT |
| Documentation | This thread handles the client request and receives |
| | client's request. |
| Operation Name | static_stdcall HelperThread |
| Arguments | LPVOID p_pParam |
| Return Type | UINT |
| Documentation | This thread manages the client. |
| Operation Name | CleanupThread |
| Arguments | WSAEVENT p_Event, WSAEVENT |
| | p_ShutdownEvent, SOCKET p_s |
| Return Type | void |
| Documentation | This thread cleans the socket. |
| Operation Name | CleanupThread |
| Arguments | WSAEVENT p_Event, SOCKET p_s, |
| | NewConnectionTag* p_pNewConn, DWORD, |
| | p_dwThreadID |
| Return Type | void |
| Documentation | This thread cleans the client handle. |
| Operation Name | AddClient |
| Arguments | SOCKET p_s, char*p_pszClientAddress, int p_iPort |
| Return Type | BOOL |
| Documentation | This method adds client info in the server stats. |

Class Name: CHTTPServer
Documentation: This class is derived from CgenericServer and provides the functionalities to start, stop and process the client's request.
Derived from: CGenericServer
Public Properties:

Protected Properties:

| | |
|---|---|
| Attribute Name | m_Visitors |
| Type | STRVECT |
| Initial Value | |
| Documentation | This member has the list of all clients currently |
| | connected to the server. |

Private Properties:

| | |
|---|---|
| Attribute Name | m_MimeTypes |
| Type | MIMETYPES |
| Initial Value | |
| Documentation | This data member indicates the MIME types of the data. |
| Attribute Name | m_szDefIndex |
| Type | string |
| Initial Value | |
| Documentation | This member holds the default page of the server. |
| Attribute Name | m_szHomeDir |
| Type | string |
| Initial Value | |
| Documentation | This data member holds the home path of the MMS |
| | server. |

Public Methods:

| | |
|---|---|
| Operation Name | Start |
| Arguments | string p_szIPAddress, int p_iPortNo, int p_iPersTo, |
| | string p_szDefIndex, string p_szhomeDir |
| Return Type | BOOL |
| Documentation | This method starts the server and sets home directory, |
| | default page and timeout of the request. |
| Operation Name | GotConnection |
| Arguments | char* p_szChar, int p_iCount |
| Return Type | int |
| Documentation | This method got the connection from the client. |
| Operation Name | IsComplete |
| Arguments | string p_szRequest |
| Return Type | BOOL |
| Documentation | This method checks whether the received request |
| | is complete or not. |
| Operation Name | ParseRequest |
| Arguments | string p_szRequest, string& p_szResponse, |
| | BOOL& p_bKeepAlive |
| Return Type | BOOL |
| Documentation | this method parses the request and process that. |

### IPAuthetuication Service Class Definitions

Class Name: CIPLog

Documentation: This class provides functionalities for writing log file and clear it.

Derived from:

Private Properties:

| | |
|---|---|
| Attribute Name | m_lTime |
| Type | long |
| Initial Value | 0 |
| Documentation | This data member holds the time when new event is |
| | going to logged in the file. |
| Attribute Name | m_pf |
| Type | FILE* |
| Initial Value | |
| Documentation | This data member holds the pointer of log file. |
| Attribute Name | m_pnewtime |
| Type | struct time* |
| Initial Value | |
| Documentation | This data member holds the event time in GMT format. |
| Attribute Name | m_szDT[128] |
| Type | char |
| Initial Value | “” |
| Documentation | This member holds the event time in formatted string. |
| Attribute Name | m_szLogFilePath[MAX_PATH] |
| Type | char |
| Initial Value | “” |
| Documentation | This member holds the path of the log file. |
| Attribute Name | m_cs |
| Type | CRITICAL_SECTION |
| Initial Value | |
| Documentation | This member is used for thread synchronization. |
| Attribute Name | m_szMessage[MAX_MSG_SIZE] |
| Type | char |
| Initial Value | |
| Documentation | this member holds the message which has to logged. |
| | MAX_MSG_SIZE macro is defined as 1024. |

Protected Properties:
Public Properties:

Public Methods:

| | |
|---|---|
| Operation Name | CLog |
| Arguments | |
| Return Type | |
| Documentation | This is the default constructor of the class, which |
| | initializes the critical section. |
| Operation Name | ˜CLog |
| Arguments | |
| Return Type | |
| Documentation | This is the destructor of the class, which deletes |
| | critical section. |
| Operation Name | LogMessage |
| Arguments | const char* p_pszFolder, const char* p_pszMsg, |
| | const char* p_pszMsgl, long p_1Number |
| Return Type | BOOL |
| Documentation | This method logs the message in the log file. |
| Operation Name | ClearLog |
| Arguments | const char*p_pszFolder |
| Return Type | BOOL |
| Documentation | This method clears the log file. |

Protected Methods:
Private Methods:
Class Name: CGenericServer
Documentation: This class creates the client thread, helper thread and provides way to connect multiple clients to the web server.
Derived from: CLog
Public Properties:

Protected Properties:

| | |
|---|---|
| Attribute Name | m_Visitors |
| Type | STRVECT |
| Initial Value | |
| Documentation | This members shows all the clients currently |
| | connected to the IPAuth Service. |

Private Properties:

| | |
|---|---|
| Attribute Name | m_cs |
| Type | CRITICAL_SECTION |
| Initial Value | |
| Documentation | This member is used for thread synchronization. |
| Attribute Name | m_csl |
| Type | CRITICAL_SECTION |
| Initial Value | |
| Documentation | This member is used for thread synchronization. |
| Attribute Name | m_bRun |
| Type | BOOL |
| Initial Value | |
| Documentation | This member indicates whether server is running or not. |
| Attribute Name | m_HandleList |
| Type | HANDLELIST |
| Initial Value | |
| Documentation | This member holds the list of all handle of client thread, |
| | when server is going to shutdown it closes all the handles |
| | then will be stop. |
| Attribute Name | m_iPersistenceTo |
| Type | int |
| Initial Value | |
| Documentation | This member holds the timeout value. |
| Attribute Name | m_iServerPort |
| Type | int |
| Initial Value | |
| Documentation | This member has the port number where IPAuth |
| | service will be running. |
| Attribute Name | m_ShutdownEvent |
| Type | WSAEVENT |
| Initial Value | |
| Documentation | This member indicates the shutdown event's value. |
| Attribute Name | m_Stats |
| Type | StatisticsTag |
| Initial Value | |
| Documentation | This is the structure variable, which holds all the |
| | information for the server. |
| Attribute Name | m_ThreadA |
| Type | HANDLE |
| Initial Value | |
| Documentation | This is the handle value of the thread. |
| Attribute Name | m_uiThreadA_ID |
| Type | unsigned int |
| Initial Value | |
| Documentation | This member holds the thread ID. |
| Attribute Name | m_ThreadC |
| Type | HANDLE |
| Initial Value | |
| Documentation | This is the handle value of the thread. |
| Attribute Name | m_uiThreadC_ID |
| Type | unsigned int |
| Initial Value | |
| Documentation | This member holds the thread ID. |
| Attribute Name | m_ThreadLaunchedEvent |
| Type | HANDLE |
| Initial Value | |
| Documentation | This member holds the handle value of event when |
| | thread is going to create. |
| Attribute Name | m_ThreadList |
| Type | THREADLIST |
| Initial Value | |
| Documentation | This data member holds the list of all thread. |
| Attribute Name | m_WaitForCloseEvent |
| Type | HANDLE |
| Initial Value | |
| Documentation | This data member holds the handle value of close event. |

Public Methods:

| | |
|---|---|
| Operation Name | GetLocalAddress |
| Arguments | LPSTR p_lpStr, LPDWORD p_lpdwStrlen |
| Return Type | int |
| Documentation | This method gets the IP address of the system on |
| | which server is running. |
| Operation Name | GetStats |
| Arguments | StatisticsTag& p_st |
| Return Type | void |
| Documentation | This method gets the statistics of the server. |
| Operation Name | Reset |
| Arguments | |
| Return Type | void |
| Documentation | This method resets the stats value. |
| Operation Name | Run |
| Arguments | CString p_strIPAdd, int p_iPort, int p_iPersTo |
| Return Type | BOOL |
| Documentation | This method starts the server on specified IP address, |
| | port number and sets timeout for that. |
| Operation Name | ShutDown |
| Arguments | |
| Return Type | BOOL |
| Documentation | This method stops the running IPAuth Service. |

Protected Methods:

| | |
|---|---|
| Operation Name | virtual IsComplete = 0 |
| Arguments | |
| Return Type | string p_szRequest |
| Documentation | This method checks whether received request |
| | is complete or partial. |
| Operation Name | virtual ParseRequest = 0 |
| Arguments | string p_szRequest, string p_szResponse, |
| | BOOL& p_bKeepAlive |
| Return Type | BOOL |
| Documentation | This method parse the request and process that. |
| Operation Name | virtual GotConnection = 0 |
| Arguments | const char*p_szChar, int p_iCount |
| Return Type | int |
| Documentation | This method receive connection. |

Private Methods:

| | |
|---|---|
| Operation Name | static_stdcall AcceptThread |
| Arguments | LPVOID p_pParam |
| Return Type | UINT |
| Documentation | This thread accept client's connection request. |
| Operation Name | static_stdcall ClientThread |
| Arguments | LPVOID p_pParam |
| Return Type | UINT |
| Documentation | This thread handles the client request and receives |
| | client's request. |
| Operation Name | static_stdcall HelperThread |
| Arguments | LPVOID p_pParam |
| Return Type | UINT |
| Documentation | This thread manages the client. |
| Operation Name | CleanupThread |
| Arguments | WSAEVENT p_Event, WSAEVENT |
| | p_ShutdownEvent, SOCKET p_s |
| Return Type | void |
| Documentation | This thread cleans the socket. |
| Operation Name | CleanupThread |
| Arguments | WSAEVENT p_Event, SOCKET p_s, |
| | NewConnectionTag* p_pNewConn, DWORD, |
| | p_dwThreadID |
| Return Type | void |
| Documentation | This thread cleans the client handle. |
| Operation Name | AddClient |
| Arguments | SOCKET p_s, char*p_pszClientAddress, int p_iPort |
| Return Type | BOOL |
| Documentation | This method adds client info in the server stats. |

### Multimedia Client (MMC) Class Definitions

Class Name: MMRApp

Documentation: This class provides functionality to instantiated the object of CloginDlg and CMMRDlg.

Derived from: CWinApp

Private Properties:

| | |
|---|---|
| Attribute Name | m_struserID |
| Type | CString |
| Initial Value | |
| Documentation | This data member holds the userid. |
| Attribute Name | m_strPwd |
| Type | CString |
| Initial Value | |
| Documentation | This member holds the password |
| Attribute Name | m_strSerKey |
| Type | CString |
| Initial Value | |
| Documentation | this member holds the serial key of the MMS server. |

Protected Properties:
Public Properties:

Public Methods:

| | |
|---|---|
| Operation Name | InitInstance |
| Arguments | |
| Return Type | BOOL |
| Documentation | This method creates the instance of CloginDlg and |
| | shows login dialog box. If auto login option is checked |
| | then it won't show login dialog box and connects to |
| | the IPAuth service to get the MMS server's info |
| | corresponding to serial key after taking MMS |
| | server's info it will connect to the MMS server |
| | and after successfully loggedin in the MMS server |
| | directly shows the MMR dialog box. |
| Operation Name | ReadValue |
| Arguments | |
| Return Type | BOOL |
| Documentation | This method reads the login info from the registry. |

Protected Methods:
Private Methods:
Class Name: CLoginDlg
Documentation: This class provides the functionalities to take the login input from the user and connect to the IPAuth service to get the MMS server's info and connect to the MMS server.
Derived from: CDialog

Public Properties:

| | |
|---|---|
| Attribute Name | m_struserID |
| Type | Cstring |
| Initial Value | |
| Documentation | This data member is associated with userid edit box. |
| Attribute Name | m_strPwd |
| Type | CString |
| Initial Value | |
| Documentation | This data member is associated with password edit box. |
| Attribute Name | m_strSerKey |
| Type | CString |
| Initial Value | |
| Documentation | This data member is associated with Serial Key edit box. |
| Attribute Name | m_bSave |
| Type | BOOL |
| Initial Value | |
| Documentation | This data member is associated with Save in |
| | references check box. |

Protected Properties:
Private Properties:

Public Methods:

| | |
|---|---|
| Operation Name | ReadValue |
| Arguments | |
| Return Type | BOOL |
| Documentation | This method reads the login info from the registry. |
| Operation Name | WriteValue |
| Arguments | |
| Return Type | BOOL |
| Documentation | This method writes the login info in the registry. |

Protected Methods:

| | |
|---|---|
| Operation Name | DoDataExchange |
| Arguments | CdataExchange* pDX |
| Return Type | void |
| Documentation | This method exchanges the data between controls |
| | and its associated variables. |
| Operation Name | OnInitDialog |
| Arguments | |
| Return Type | BOOL |
| Documentation | This method executes when dialog box is going to |
| | show and calls ReadValue method. If m_bSave is |
| | true then it shows login info in the dialog box. |
| Operation Name | OnCancel |
| Arguments | |
| Return Type | void |
| Documentation | This method simply closes the dialog box. |
| Operation Name | OnLogin |
| Arguments | |
| Return Type | void |
| Documentation | This method writes login info in the registry and |
| | connects to the IPAuth service to get the MMS |
| | server's info corresponding to serial key after |
| | taking MMS server's info it connects to the MMS |
| | server. It calls Write Value method. |

Private Methods:
Class Name: CMMRDlg
Documentation: This class provides the functionalities to change password, stream and play file, save preferences, search for the music files in the MMS server, login as different user and logout.
Derived from: CDialog

Public Properties:

| | |
|---|---|
| Attribute Name | m_strKey |
| Type | CString |
| Initial Value | |
| Documentation | This data member holds the keyword for searching |
| | and associated with keyword edit box. |
| Attribute Name | m_ctrlSong |
| Type | ClistCtrl |
| Initial Value | |
| Documentation | This data member is associated with list control. |

Protected Properties:
Private Properties:

Public Methods:

| | |
|---|---|
| Operation Name | ParseBuffer |
| Arguments | CString p_strBuffer |
| Return Type | void |
| Documentation | This method parse the XML buffer received from the |
| | MMS server and shows data in list control. |

Protected Methods:

| | |
|---|---|
| Operation Name | DoDataExchange |
| Arguments | CdataExchange* pDX |
| Return Type | void |
| Documentation | This method exchanges the data between controls and its associated |
| | variables. |
| Operation Name | OnInitDialog |
| Arguments | |
| Return Type | BOOL |
| Documentation | This method executes when dialog box is going to show and sends |
| | blank keyword search for play list request to the MMS server and will |
| | call ParseBuffer method to parse the response and shows data in the |
| | list control. When it will wait for the response from the MMS server it |
| | will show progress bar. If in between user clicks on cancel search |
| | button it will send cancel search request to the MMS server and MMS |
| | server will send whole XML file as response. |
| Operation Name | OnCancel |
| Arguments | |
| Return Type | void |
| Documentation | This method simply closes the dialog box. |
| Operation Name | OnLogin |
| Arguments | |
| Return Type | void |
| Documentation | This method opens login dialog box if user wants to login as different |
| | user. Before sending the request login as different user to the MMS |
| | server it will send logout request of the current user to the MMS |
| | server and on getting successful response it will send login as |
| | different user's request. |
| Operation Name | OnLogout |
| Arguments | |
| Return Type | void |
| Documentation | This method will send logout request to the MMS server. |
| Operation Name | OnPreferences |
| Arguments | |
| Return Type | void |
| Documentation | This method will open preferences dialog box. |
| Operation Name | OnChangePassword |
| Arguments | |
| Return Type | void |
| Documentation | This method will open change password dialog box. |
| Operation Name | OnOK |
| Arguments | |
| Return Type | void |
| Documentation | This method simply closes the dialog box. |
| Operation Name | OnPlay |
| Arguments | |
| Return Type | void |
| Documentation | This method will send selected songs request to the MMS server and |
| | after getting successful response it will play that file in the default |
| | music player. |
| Operation Name | OnSearch |
| Arguments | |
| Return Type | void |
| Documentation | This method will send search request according to option selected to |
| | the MMS server and after getting successfully response it will parse |
| | the response and will show in the list control. |
| Operation Name | OnCancelSearch |
| Arguments | |
| Return Type | void |
| Documentation | This method will send cancel search request to the MMS server and |
| | MMS server will send whole XML file as response, after getting this |
| | response it will parse the response and will show in the list control. |

Private Methods:
Class Name: CChangePwdDlg
Documentation: This class provides functionality to change the password.
Derived from: CDialog

Public Properties:

| | |
|---|---|
| Attribute Name | m_strUserID |
| Type | CString |
| Initial Value | |
| Documentation | This data member is associated with user id edit box. |
| Attribute Name | m_strPwd |
| Type | CString |
| Initial Value | |
| Documentation | This data member is associated with current password |
| | edit box. |
| Attribute Name | m_strNewPwd |
| Type | CString |
| Initial Value | |
| Documentation | This data member is associated with new password |
| | edit box. |
| Attribute Name | m_strCnfPwd |
| Type | CString |
| Initial Value | |
| Documentation | This data member is associated with confirm password |
| | edit box. |

Protected Properties:
Private Properties:

Public Methods:

| | |
|---|---|
| Operation Name | ReadValue |
| Arguments | |
| Return Type | BOOL |
| Documentation | This method will read the current login info from |
| | the registry. |
| Operation Name | WriteValue |
| Arguments | |
| Return Type | BOOL |
| Documentation | This method will write login info in the registry. |

Protected Methods:

| | |
|---|---|
| Operation Name | DoDataExchange |
| Arguments | CdataExchange* pDX |
| Return Type | Void |
| Documentation | This method exchanges the data between controls |
| | and its associated variables. |
| Operation Name | OnInitDialog |
| Arguments | |
| Return Type | BOOL |
| Documentation | This method executes when dialog box is going to |
| | show. It will call ReadValue method and will update |
| | the data members. |
| Operation Name | OnCancel |
| Arguments | |
| Return Type | void |
| Documentation | This method simply closes the dialog box. |
| Operation Name | OnOk |
| Arguments | |
| Return Type | void |
| Documentation | This method will prepare change password request and |
| | will send to the MMS server, after getting successful |
| | response it will call WriteValue method. |

Private Methods:
Class Name: CMMRPrefDlg
Documentation: This class provides functionality to change the preferences info.
Derived from: CDialog

Public Properties:

| | |
|---|---|
| Attribute Name | m_strUserID |
| Type | CString |
| Initial Value | |
| Documentation | This data member is associated with user id edit box. |
| Attribute Name | m_strPwd |
| Type | CString |
| Initial Value | |
| Documentation | This data member is associated with current password |
| | edit box. |
| Attribute Name | m_sdtrSerKey |
| Type | CString |
| Initial Value | |
| Documentation | This data member is associated with Serial Key edit box. |

Protected Properties:
Private Properties:

Public Methods:

| | |
|---|---|
| Operation Name | ReadValue |
| Arguments | |
| Return Type | BOOL |
| Documentation | This method will read the current preferences info |
| | from the registry. |
| Operation Name | WriteValue |
| Arguments | |
| Return Type | BOOL |
| Documentation | This method will write preferences info in the registry. |

Protected Methods:

| | |
|---|---|
| Operation Name | DoDataExchange |
| Arguments | CdataExchange* pDX |
| Return Type | void |
| Documentation | This method exchanges the data between controls and |
| | its associated variables. |
| Operation Name | OnInitDialog |
| Arguments | |
| Return Type | BOOL |
| Documentation | This method executes when dialog box is going to |
| | show. It will call ReadValue method and will update |
| | the data members. |
| Operation Name | OnCancel |
| Arguments | |
| Return Type | void |
| Documentation | This method simply closes the dialog box. |
| Operation Name | OnSave |
| Arguments | |
| Return Type | void |
| Documentation | This method will save preferences info in the |
| | registry using WriteValue method. |

Private Methods:
Class Name: CClient
Documentation: This class provides functionality to change the preferences info.
Derived from: CDialog
Public Properties:
Protected Properties:
Private Properties:

Public Methods:

| | |
|---|---|
| Operation Name | Connect |
| Arguments | CString p_strUserID, Cstringp_strPwd, |
| | CString p_strSerKey |
| Return Type | BOOL |
| Documentation | This method will connect to the IPAuth service and |
| | request for MMS server's info corresponding to serial |
| | key. After getting MMS server's info from the IPAuth |
| | service it will connect to MMS server. |
| Operation Name | Close |
| Arguments | |
| Return Type | void |
| Documentation | This method will close the connection from the MMS |
| | server. |
| Operation Name | SendData |
| Arguments | SOCKET p_ps, const char* p_pszBuf, long |
| | p_pBufLen |
| Return Type | DWORD |
| Documentation | This method will send request to the server. |
| Operation Name | ReceiveData |
| Arguments | char* p_pszBuf, long p_pBufLen |
| Return Type | DWORD |
| Documentation | This method will receive data from the server. |

Protected Methods:
Private Methods:

### Dialog Box Definitions and Screen Shots

The dialog box definitions for the example music player application will now be presented. In addition, screen shots associated with several of the dialog boxes are provided.

### Music Application Dialog Box

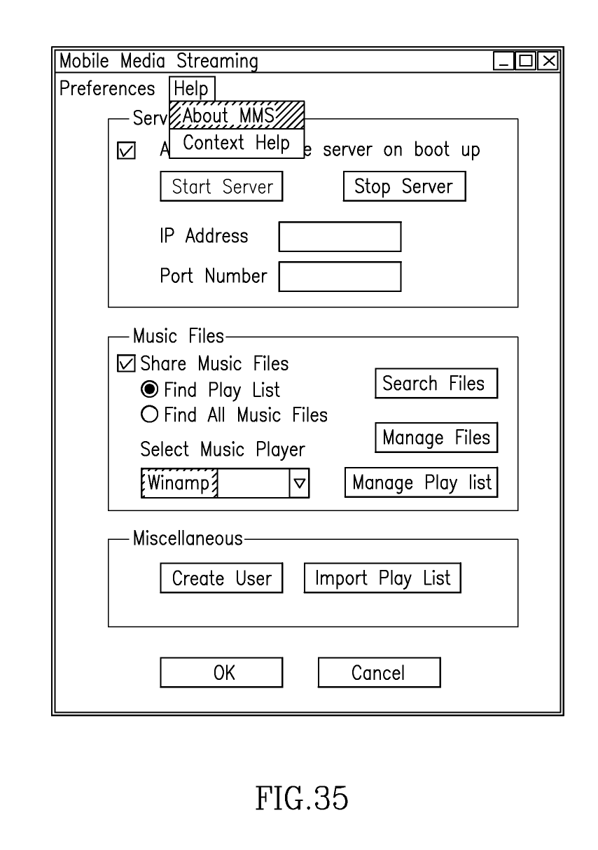

The dialog box definition for the Music Application is presented below. A screen shot of the Music Application main dialog box is shown in FIG. 35.

| Parent Name | CMMSDlg |
|---|---|
| Control ID | IDC_AUTO_START |
| Caption | Automatic start server on bootup |
| Control Type | Check box |
| Description | |
| Control ID | IDC_START_SERVER |
| Caption | Start Server |
| Control Type | Push button |
| Description | Id server will be running then this control will be disabled |
| Control ID | IDC_STOP_SERVER |
| Caption | Stop Server |
| Control Type | Push button |
| Description | If MMS server will not be running then this control will |
| | be disabled |
| Control ID | IDC_IP_ADDRESS |
| Caption | |
| Control Type | Edit box |
| Description | This control will be disabled show the IP address of the |
| | MMS server. |
| Control ID | IDC_PORT_NUMBER |
| Caption | |
| Control Type | Edit box |
| Description | This control will be disabled show the Port Number of the |
| | MMS server. |
| Control ID | IDC_SHARE_FILE |
| Caption | |
| Control Type | Check box |
| Description | |
| Control ID | IDC_PLAY_LIST |
| Caption | Find Play List |
| Control Type | Radio button |
| Description | |
| Control ID | IDC_MUSIC_FILE |
| Caption | Find All Music File |
| Control Type | Radio button |
| Description | |
| Control ID | IDC_MUSIC_PLAYER |
| Caption | |
| Control Type | Combo box |
| Description | This control will show all the music player installed on |
| | thePC. |
| Control ID | IDC_SEARCH_FILES |
| Caption | Search Files |
| Control Type | Push button |
| Description | |
| Control ID | IDC_MANAGE_PLAY_LIST |
| Caption | Manage Play List |
| Control Type | Push button |
| Description | |
| Control ID | IDC_MANAGE_FILES |
| Caption | Manage Files |
| Control Type | Push button |
| Description | |
| Control ID | IDC_CREATE_USER |
| Caption | Create User |
| Control Type | Push Button |
| Description | |
| Control ID | IDC_IMPORT_PLAY_LIST |
| Caption | Import Play List |
| Control Type | Push button |
| Description | |
| Control ID | IDOK |
| Caption | OK |
| Control Type | Push button |
| Description | |
| Control ID | IDCANCEL |
| Caption | Cancel |
| Control Type | Push button |
| Description | |
| Control ID | IDC_PREFERENCES |
| Caption | Preferences |
| Control Type | Menu |
| Description | |
| Control ID | IDC_CONTEXT_HELP |
| Caption | Context Help |
| Control Type | Menu |
| Description | |
| Control ID | IDC_ABOUT_MMS |
| Caption | About MMS |
| Control Type | Menu |
| Description | |

### Show Music Files Dialog Box

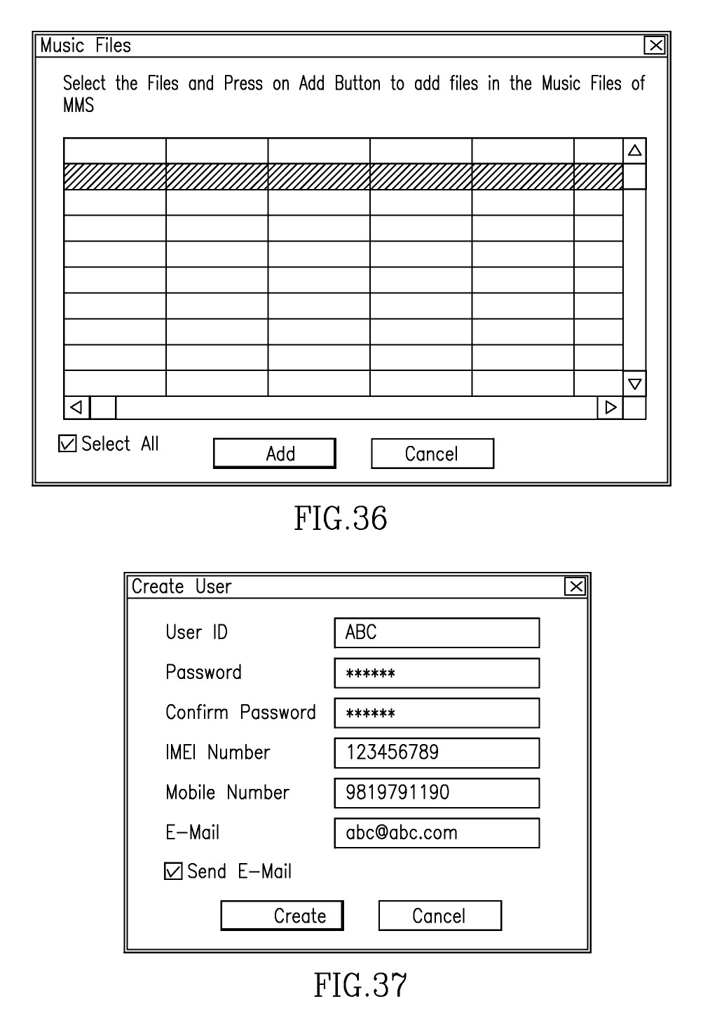

The dialog box definition for the Show Music Files is presented below. A screen shot of an example Show Music Files dialog box of the example music retrieval system is shown in FIG. 36.

| Parent Name | CMusicFileDlg |
|---|---|
| Control ID | IDC_DATA |
| Caption | |
| Control Type | Flex Grid control |
| Description | |
| Control ID | IDC_ADD |
| Caption | Add |
| Control Type | Push button |
| Description | |
| Control ID | IDCANCEL |
| Caption | Cancel |
| Control Type | Push button |
| Description | |
| Control ID | IDC_SELECT_ALL |
| Caption | Select All |
| Control Type | Check box |
| Description | |
| Control ID | IDC_DELETE |
| Caption | Delete |
| Control Type | Push button |
| Description | |

### Create User Dialog Box

The dialog box definition for the Create User is presented below. A screen shot of an example Create User dialog box of the example music retrieval system is shown in FIG. 37.

| Parent Name | CuserDlg |
|---|---|
| Control ID | IDC_USER_ID |
| Caption | |
| Control Type | Edit box |
| Description | |
| Control ID | IDC_PASSWORD |
| Caption | |
| Control Type | Edit box |
| Description | |
| Control ID | IDC_CONFIRM_PASSWORD |
| Caption | |
| Control Type | Edit box |
| Description | |
| Control ID | IDC_IMEI_NUMBER |
| Caption | |
| Control Type | Edit box |
| Description | |
| Control ID | IDC_MOBILE_NUMBER |
| Caption | |
| Control Type | Edit box |
| Description | |
| Control ID | IDC_EMAIL |
| Caption | |
| Control Type | Edit box |
| Description | |
| Control ID | IDC_SEND_MAIL |
| Caption | |
| Control Type | Check box |
| Description | |
| Control ID | IDC_CREATE |
| Caption | |
| Control Type | Push button |
| Description | |
| Control ID | IDCANCEL |
| Caption | |
| Control Type | Push button |
| Description | |

### Music Player Dialog Box

The dialog box definition for the Music Player is presented below.

| Parent Name | CPlayerDlg |
|---|---|
| Control ID | IDC_MUSIC_PLAYER |
| Caption | |
| Control Type | List box |
| Description | |
| Control ID | IDOK |
| Caption | OK |
| Control Type | Push button |
| Description | |
| Control ID | IDCANCEL |
| Caption | cancel |
| Control Type | Push button |
| Description | |

### About MMS Dialog Box

The dialog box definition for the About MMS is presented below.

| Parent Name | CAboutMMSDlg |
|---|---|
| Control ID | IDOK |
| Caption | OK |
| Control Type | Push button |
| Description | |

### MMS Preferences Dialog Box

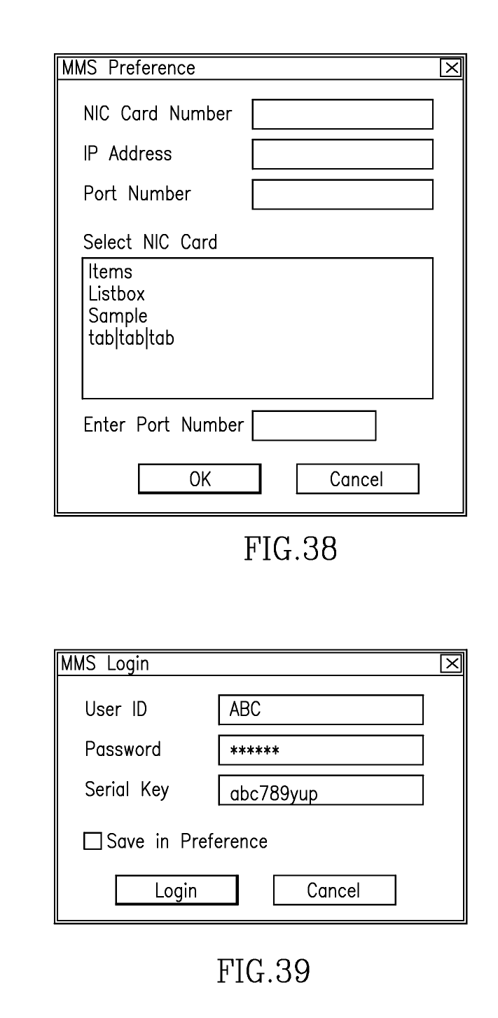

The dialog box definition for the MMS Preferences is presented below. A screen shot of an example MMS Preferences dialog box of the example music retrieval system is shown in FIG. 38.

| Parent Name | CPrefDlg |
|---|---|
| Control ID | IDC_NIC_CARD |
| Caption | |
| Control Type | Edit box |
| Description | Disabled |
| Control ID | IDC_IP_ADDRESS |
| Caption | |
| Control Type | Edit box |
| Description | Disabled |
| Control ID | IDC_PORT_NUMBER |
| Caption | |
| Control Type | Edit box |
| Description | Disabled |
| Control ID | IDC_NEW_PORT_NUMBER |
| Caption | |
| Control Type | Edit box |
| Description | |
| Control ID | IDC_NIC_CARD_LIST |
| Caption | |
| Control Type | List box |
| Description | |

### MMC Login Dialog Box

The dialog box definition for the MMC Login is presented below. A screen shot of an example MMC Login dialog box of the example music retrieval system is shown in FIG. 39.

| | |
|---|---|
| Parent Name | CloginDlg |
| Control ID | IDC_USER_ID |
| Caption | |
| Control Type | Edit box |
| Description | |
| Parent Name | CloginDlg |
| Control ID | IDC_PASSWORD |
| Caption | |
| Control Type | Edit box |
| Description | |
| Parent Name | CloginDlg |
| Control ID | IDC_SERIAL_KEY |
| Caption | |
| Control Type | Edit box |
| Description | |
| Parent Name | CloginDlg |
| Control ID | IDC_SAVE |
| Caption | |
| Control Type | Check box |
| Description | |
| Parent Name | CloginDlg |
| Control ID | IDC_LOGIN |
| Caption | Login |
| Control Type | Push button |
| Description | |
| Parent Name | CloginDlg |
| Control ID | IDCANCEL |
| Caption | Cancel |
| Control Type | Push button |
| Description | |

### MMC Search Dialog Box

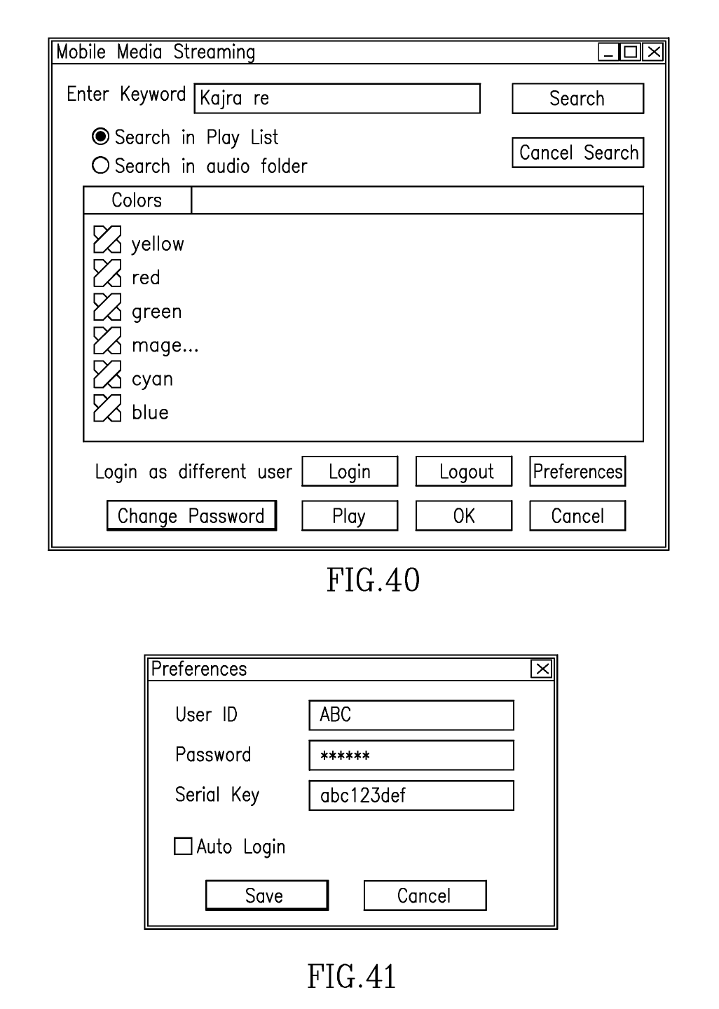

The dialog box definition for the MMC Search is presented below. A screen shot of an example MMC Search dialog box of the example music retrieval system is shown in FIG. 40.

| | |
|---|---|
| Parent Name | CMMRDlg |
| Control ID | IDC_KEYWORD |
| Caption | |
| Control Type | Edit box |
| Description | |
| Parent Name | CloginDlg |
| Control ID | IDC_SEARCH |
| Caption | Search |
| Control Type | Push button |
| Description | |
| Parent Name | CloginDlg |
| Control ID | IDC_CANCEL_SEARCH |
| Caption | Cancel Search |
| Control Type | Push button |
| Description | |
| Parent Name | CloginDlg |
| Control ID | IDC_PLAY_LIST |
| Caption | Search in play List |
| Control Type | Radio button |
| Description | |
| Parent Name | CloginDlg |
| Control ID | IDC_AUDIO_FOLDER |
| Caption | Search in audio folder |
| Control Type | Radio button |
| Description | |
| Parent Name | CloginDlg |
| Control ID | IDC_SONG |
| Caption | |
| Control Type | List Control |
| Description | |
| Parent Name | CloginDlg |
| Control ID | IDC_LOGIN |
| Caption | Login |
| Control Type | Push button |
| Description | |
| Parent Name | CloginDlg |
| Control ID | IDC_LOGOUT |
| Caption | Logout |
| Control Type | Push button |
| Description | |
| Parent Name | CloginDlg |
| Control ID | IDC_PREFERENCES |
| Caption | Preferences |
| Control Type | Push button |
| Description | |
| Parent Name | CloginDlg |
| Control ID | IDC_CHANGE_PASSWORD |
| Caption | Change Password |
| Control Type | Push button |
| Description | |
| Parent Name | CloginDlg |
| Control ID | IDC_Play |
| Caption | Play |
| Control Type | Push button |
| Description | |
| Parent Name | CloginDlg |
| Control ID | IDOK |
| Caption | OK |
| Control Type | Push button |
| Description | |
| Parent Name | CloginDlg |
| Control ID | IDCANCEL |
| Caption | Cancel |
| Control Type | Push button |
| Description | |

### MMC Change Password Dialog Box

The dialog box definition for the MMC Change Password is presented below.

| | |
|---|---|
| Parent Name | CchangePwdDlg |
| Control ID | IDC_USERID |
| Caption | |
| Control Type | Edit box |
| Description | |
| Parent Name | CchangePwdDlg |
| Control ID | IDC_CURRENT_PASSWORD |
| Caption | |
| Control Type | Edit box |
| Description | |
| Parent Name | CchangePwdDlg |
| Control ID | IDC_NEW_PASSWORD |
| Caption | |
| Control Type | Edit box |
| Description | |
| Parent Name | CchangePwdDlg |
| Control ID | IDC_CONFIRMED_PASSWORD |
| Caption | |
| Control Type | Edit box |
| Description | |
| Parent Name | CchangePwdDlg |
| Control ID | IDOK |
| Caption | OK |
| Control Type | Push button |
| Description | |
| Parent Name | CchangePwdDlg |
| Control ID | IDCANCEL |
| Caption | Cancel |
| Control Type | Push button |
| Description | |

### MMC Preferences Dialog Box

The dialog box definition for the MMC Preferences is presented below. A screen shot of an example MMC Preferences dialog box of the example music retrieval system is shown in FIG. 41.

| | |
|---|---|
| Parent Name | CPrefDlg |
| Control ID | IDC_USER_ID |
| Caption | |
| Control Type | Edit box |
| Description | |
| Parent Name | CPrefDlg |
| Control ID | IDC_PASSWORD |
| Caption | |
| Control Type | Edit box |
| Description | |
| Parent Name | CPrefDlg |
| Control ID | IDC_SERIAL_KEY |
| Caption | |
| Control Type | Edit box |
| Description | |
| Parent Name | CPrefDlg |
| Control ID | IDC_AUTO_LOGIN |
| Caption | |
| Control Type | Check box |
| Description | |
| Parent Name | CPrefDlg |
| Control ID | IDC_SAVE |
| Caption | Save |
| Control Type | Push button |
| Description | |
| Parent Name | CPrefDlg |
| Control ID | IDCANCEL |
| Caption | Cancel |
| Control Type | Push button |
| Description | |

In alternative embodiments, the methods of the present invention may be applicable to implementations of the invention in integrated circuits, field programmable gate arrays (FPGAs), chip sets or application specific integrated circuits (ASICs), DSP circuits, wireless implementations and other communication system products.

It is intended that the appended claims cover all such features and advantages of the invention that fall within the spirit and scope of the present invention. As numerous modifications and changes will readily occur to those skilled in the art, it is intended that the invention not be limited to the limited number of embodiments described herein. Accordingly, it will be appreciated that all suitable variations, modifications and equivalents may be resorted to, falling within the spirit and scope of the present invention.

What is claimed is:

1. A method of delivering personal computer (PC) content over a network, said method comprising the steps of:
rendering, on a multimedia server (MMS), a plurality of PC based items as really simple syndication (RSS) documents and storing said RSS documents in memory;
generating, on a multimedia client (MMC), a request for one or more RSS documents;
in response to said request, retrieving one or more RSS documents on said server from said memory; and
sending said one or more RSS documents retrieved to said multimedia client.

2. The method according to claim 1, wherein said step of rendering comprises the steps of:
reading a directory or file name from among said PC content; and
encapsulating said directory or file name into an RSS element.

3. The method according to claim 1, wherein said step of rendering comprises the steps of:
communicating with an application via an application programming interface (API) corresponding thereto;
storing user specified data selections from said application in a configuration database;
retrieving application data selections; and
generating a representation of said application data selections for storing in said database.

4. The method according to claim 1, wherein said request comprises an application ID and an element ID.

5. The method according to claim 1, wherein said step of retrieving comprises the step of retrieving configuration and related data from a configuration database based on an application ID extracted from said request.

6. The method according to claim 1, wherein said step of rendering comprises the steps of:
creating an index of application data derived from a plurality of applications; and
storing index and configuration information for accessing application data in response to client requests in a configuration database.

7. The method according to claim 1, further comprising the step of registering said MMS on an authentication server wherein each MMS is assigned a unique serial number.

8. The method according to claim 1, further comprising the step of obtaining an internet protocol (IP) address of an MMS from an authentication server in response to a unique serial number corresponding to said MMS provided thereto.

9. The method according to claim 1, wherein said MMC comprises a conventional web browser.

10. A method of delivering personal computer (PC) content over a network, said method comprising the steps of:
requesting from an authentication service a location of a multimedia server (MMS) running on a user's PC;
establishing a peer-to-peer connection between a multimedia client (MMC) and said MMS;
rendering, on said MMS, a plurality of PC based items as really simple syndication (RSS) documents and storing said RSS documents in memory;
generating on said MMC a request for one or more RSS documents and forwarding said request to said MMS;
in response to said request, retrieving one or more RSS documents on said MMS from said memory; and
sending said one or more RSS documents retrieved to said MMC.

11. The method according to claim 10, wherein said MMC comprises a conventional web browser.

12. The method according to claim 10, wherein said step of rendering comprises the steps of:
creating a unique application ID for each application, each application having a dataset comprising a plurality of data elements; and
creating a unique element ID for each data element within an application's dataset as identified by the user.

13. A system for delivering personal computer (PC) content over a network, comprising:
a really simple syndication (RSS) document database located on one or more servers, said RSS document database for storing one or more RSS documents, each RSS document associated with a particular PC based item;
one or more multimedia clients (MMCs) coupled to said network, each MMC operative to generate a request message for an RSS document in response to a user input command, each MMC operative to send said request message to a multimedia server (MMS) coupled to said network, and to process and display said requested RSS document received from said MMS; and
said MMS operative to render a plurality of PC items, each PC item rendered as an RSS document stored in said RSS document database, said MMS operative to receive said request message from said MMC and, in response thereto, to retrieve said requested RSS document from said RSS database and forward said requested RSS document to said MMC.

14. The system according to claim 13, wherein said MMS is operative to render a PC item by reading a directory or file name from among said PC content and encapsulating said directory or file name into an RSS element.

15. The system according to claim 10, wherein said MMS comprises means for rendering comprising:
means for communicating with an application via an application programming interface (API) corresponding thereto;
means for storing user specified data selections from said application in a configuration database;
means for retrieving application data selections; and
means for generating a representation of said application data selections for storing in said database.

16. The system according to claim 13, wherein said user input command comprises clicking on a link on a web page.

17. The system according to claim 13, wherein said MMS is operative to encrypt said RSS document before storage in said RSS document database.

18. The system according to claim 13, wherein said MMS is operative to decrypt said RSS document after retrieval from said RSS document database.

19. The system according to claim 13, wherein said MMS further comprises means for retrieving data from within an application data file in response to a user request for additional application data.

20. A method of delivering personal computer (PC) content over a network for use on a multimedia server (MMS) computer coupled to said network, said method comprising the steps of:
rendering a plurality of PC based items as really simple syndication (RSS) documents and storing said RSS documents in an RSS document database;
receiving a request for one or more RSS documents from a multimedia client (MMC) coupled to said network;
in response to said request, retrieving one or more RSS documents from said RSS document database; and
sending said one or more requested RSS documents to said multimedia client.

21. The method according to claim 20, wherein said step of rendering comprises the steps of:
reading a directory or file name from among said PC content; and
encapsulating said directory or file name into an RSS element.

22. The method according to claim 20, wherein said step of rendering comprises the steps of:
communicating with an application via an application programming interface (API) corresponding thereto;
storing user specified data selections from said application in a configuration database;
retrieving application data selections; and
generating a representation of said application data selections for storing in said database.

23. The method according to claim 20, wherein said step of rendering comprises the step of rendering data from one or more applications wherein each application accessed is assigned a unique ID that is stored in a master application dataset.

24. The method according to claim 20, wherein said step of rendering comprises the steps of:
creating an index of application data derived from a plurality of applications; and
storing index and configuration information for accessing application data in response to client requests in a configuration database.

25. A multimedia server (MMS) coupled to a network for delivering personal computer (PC) content over said network, comprising:
a really simple syndication (RSS) document database for storing one or more RSS documents, each RSS document associated with a particular PC based item;
a user configuration database for storing an index of application related data selected to be viewed by a user;
a web server operative to receiving requests for RSS documents from one or more multimedia clients (MMCs) coupled to said network and to display a web page containing said requested RSS document to said MMC; and
an RSS agent coupled to said RSS document database, said user configuration database and said web server, said RSS agent operative to render user selected PC based items as RSS documents utilizing said user configuration database and to store said RSS documents in said RSS document database, said RSS agent operative to retrieve an RSS document from said RSS document database in response to a request received from an MMC and to forward said requested RSS document to said requesting MMC, said RSS agent operative to retrieve application specific data utilizing said user configuration database in response to a corresponding request received from an MMC.

26. The MMS according to claim 25, wherein said RSS agent comprises means for rendering comprising:
means for reading a directory or file name from among said PC content; and
means for encapsulating said directory or file name into an RSS element.

27. The MMS according to claim 25, wherein said RSS agent comprises:
an interface for allowing a user to select PC items to be indexed along with an associated type of indexing; and
means for storing said selections and desired type of indexing in said user configuration file.

28. The MMS according to claim 25, wherein said RSS agent comprises means for rendering comprising:
means for creating an index of application data derived from a plurality of applications; and
means for storing index and configuration information for accessing application data in response to client requests in said user configuration database.

29. The MMS according to claim 25, wherein said RSS agent comprises means for rendering comprising:
means for creating a unique application ID for each application, each application having a dataset comprising a plurality of data elements; and
means for creating a unique element ID for each data element within an application's dataset as identified by the user.

30. A computer program product, comprising:
a computer usable medium having computer usable program code for delivering personal computer (PC) content over a network, said computer program product including;
computer usable program code for rendering a plurality of PC based items as really simple syndication (RSS) documents and storing said RSS documents in an RSS document database;
computer usable program code for receiving a request for one or more RSS documents from a multimedia client (MMC) coupled to said network;
computer usable program code for in response to said request, retrieving one or more RSS documents from said RSS document database; and
computer usable program code for sending said one or more requested RSS documents to said multimedia client.

31. The computer program product according to claim 30, wherein said step of rendering comprises the steps of:
reading a directory or file name from among said PC content; and
encapsulating said directory or file name into an RSS element.

32. The computer program product according to claim 30, wherein said step of rendering comprises the steps of:
communicating with an application via an application programming interface (API) corresponding thereto;
storing user specified data selections from said application in a configuration database;
retrieving application data selections; and
generating a representation of said application data selections for storing in said database.

33. The computer program product according to claim 30, wherein said step of rendering comprises the step of rendering data from one or more applications wherein each application accessed is assigned a unique ID that is stored in a master application dataset.

34. The computer program product according to claim 30, wherein said step of rendering comprises the steps of:
creating an index of application data derived from a plurality of applications; and
storing index and configuration information for accessing application data in response to client requests in a configuration database.
